(19) United States
(12) Patent Application Publication
(10) Pub. No.: US 2025/0287135 A1
(43) Pub. Date: Sep. 11, 2025

(54) NOISE CANCELLATION METHOD, HEADSET, APPARATUS, STORAGE MEDIUM, AND COMPUTER PROGRAM PRODUCT

(71) Applicant: HUAWEI TECHNOLOGIES CO., LTD., Shenzhen (CN)

(72) Inventors: Yulong LI, Shenzhen (CN); Jiasheng LI, Shenzhen (CN); Shan OUYANG, Shenzhen (CN); Guopeng WU, Shenzhen (CN); Peinian YANG, Shenzhen (CN); Fan FAN, Shenzhen (CN)

(21) Appl. No.: 19/218,784

(22) Filed: May 27, 2025

Related U.S. Application Data
(63) Continuation of application No. PCT/CN2023/103245, filed on Jun. 28, 2023.

(30) Foreign Application Priority Data
Nov. 28, 2022 (CN) 202211505288.9

(51) Int. Cl. H04R 1/10; G10K 11/178

(52) U.S. Cl. CPC H04R 1/1083; G10K 11/17815; G10K 2210/1081; G10K 2210/3012; G10K 2210/3026; G10K 2210/3027; G10K 2210/3028; H04R 2460/01

(57) ABSTRACT

This application discloses a noise cancellation method, a headset, an apparatus, a storage medium, and a computer program product, and relates to the field of audio processing technologies. The headset includes at least one first reference microphone, one error microphone, at least one speaker, and one first FF filter. The method includes: determining a target noise cancellation parameter based on a reference signal collected by the at least one first reference microphone, an error signal collected by the error microphone, and an initial noise cancellation coefficient, where the target noise cancellation parameter includes a filter coefficient of the first FF filter; and performing noise cancellation through a target speaker in the at least one speaker based on the target noise cancellation parameter.

### CROSS-REFERENCE TO RELATED APPLICATIONS

This application is a continuation of International Application No. PCT/CN2023/103245, filed on Jun. 28, 2023, which claims priority to Chinese Patent Application No. 202211505288.9, filed on Nov. 28, 2022. The disclosures of the aforementioned applications are hereby incorporated by reference in their entireties.

### TECHNICAL FIELD

This application relates to the field of audio processing technologies, and in particular, to a noise cancellation method, a headset, an apparatus, a storage medium, and a computer program product.

### BACKGROUND

When a user wears a headset to listen to audio signals such as music or a voice, definition of the audio signals heard by the user is affected if there is environment noise, and the user cannot even hear the audio signals in the headset clearly when the environment noise is severe. Therefore, active noise cancellation of the headset needs to be implemented, to eliminate, as much as possible, the environment noise heard by the headset wearer.

There are many challenges in the active noise cancellation of the headset. The environment noise is variable and irregular. In addition, an extent to which the environment noise leaks into an ear canal is related to a degree of fitting between the headset and the human ear. However, different people have different ear canal sizes and shapes, and when different people wear a same headset, degrees of fitting between the headsets and human ears are different, resulting in different noise leakage degrees. When a same user wears a same headset a plurality of times, degrees of fitting between the headset and the human ear may also be different. In addition, currently, active noise cancellation is basically performed based on a downlink signal, and active noise cancellation cannot be performed when there is no downlink signal. Therefore, how to improve effect of active noise cancellation of a headset to avoid impact of environment noise on a headset wearer as much as possible is a current research hotspot.

### SUMMARY

This application provides a noise cancellation method, a headset, an apparatus, a storage medium, and a computer program product. This can eliminate dependence on a downlink signal, so that a target noise cancellation parameter can be determined even when there is no downlink signal, to perform adaptive noise cancellation. The technical solutions are as follows.

According to a first aspect, a noise cancellation method is provided, applied to a headset. The headset includes at least one first reference microphone, one error microphone, at least one speaker, and one first feedforward (FF) filter. The method includes: determining a target noise cancellation parameter based on a reference signal collected by the at least one first reference microphone, an error signal collected by the error microphone, and an initial noise cancellation coefficient, where the target noise cancellation parameter includes a filter coefficient of the first FF filter; and performing noise cancellation through a target speaker in the at least one speaker based on the target noise cancellation parameter.

In this application, the target noise cancellation parameter may be determined based on the reference signal collected by the at least one first reference microphone, the error signal collected by the error microphone, and the initial noise cancellation coefficient. This eliminates dependence on a downlink signal, so that the target noise cancellation parameter can be determined even when there is no downlink signal, to perform adaptive noise cancellation.

According to the noise cancellation method provided in embodiments of this application, the target noise cancellation parameter can be determined on a per-frame basis. In other words, a group of target noise cancellation parameters are determined in each frame. Certainly, the target noise cancellation parameter can alternatively be determined in another time unit. For example, a group of target noise cancellation parameters are determined in every two frames. The following uses a frame as a unit for description.

When the headset includes the first FF filter, the target noise cancellation parameter includes a k^{th}-frame filter coefficient of the first FF filter, where k is an integer greater than or equal to 1. In some cases, the headset further includes a feedback (FB) filter. In this case, the target noise cancellation parameter further includes a k^{th}-frame filter coefficient of the FB filter. In addition, when the headset further includes a downlink compensation filter, the plurality of groups of target noise cancellation parameters further include a k^{th}-frame filter coefficient of the downlink compensation filter. In addition, when k is greater than 1, a target noise canceling level may be further determined. Therefore, the following separately describes the four parts.

(1) Determine the k^{th}-Frame Filter Coefficient of the First FF Filter.

When k is equal to 1, an initial filter coefficient of the first FF filter is determined as the k^{th}-frame filter coefficient of the first FF filter, that is, a first-frame filter coefficient of the first FF filter is the initial filter coefficient of the first FF filter, or the k^{th}-frame filter coefficient of the first FF filter is determined based on an initial noise canceling level and a mapping relationship between a noise canceling level and a first FF filter coefficient. When k is greater than 1, the k^{th}-frame filter coefficient of the first FF filter is determined based on a (k−1)^{th}-frame reference signal collected by the at least one first reference microphone, a (k−1)^{th}-frame error signal collected by the error microphone, and the target noise canceling level. In other words, the k^{th}-frame filter coefficient of the first FF filter is determined according to an adaptation method. The determining process is an adaptation process, and may also be referred to as an iteration process.

It should be noted that the initial noise cancellation coefficient includes an initial filter coefficient of the first FF filter, the initial filter coefficient of the first FF filter may be determined in advance, and the initial filter coefficient may or may not be 0. This is not limited in embodiments of this application. The initial noise canceling level may be a preset level, and the level is a level at which noise cancellation can be normally performed by using a corresponding noise cancellation coefficient without introducing a stability problem. Certainly, the initial noise canceling level may alternatively be a level determined based on a prompt tone like “Noise cancellation on” or “Dingdong” sent by a user terminal when noise cancellation starts. A noise cancellation coefficient corresponding to the level can better adapt to a current human ear and wearing posture, and a convergence state can be reached more quickly by performing adaptive iteration based on the noise cancellation coefficient corresponding to the level. This is also not limited in embodiments of this application.

An implementation process of determining the k^{th}-frame filter coefficient of the first FF filter based on the (k−1)^{th}-frame reference signal collected by the at least one first reference microphone, the (k−1)^{th}-frame error signal collected by the error microphone, and the target noise canceling level includes: determining a (k−1)^{th}-frame filter coefficient of a target secondary path (SP) based on the target noise canceling level and a mapping relationship between a noise canceling level and a filter coefficient of an SP, where the target SP is a path from the target speaker to the error microphone; and determining the k^{th}-frame filter coefficient of the first FF filter based on the (k−1)^{th}-frame reference signal collected by the at least one first reference microphone, the (k−1)^{th}-frame error signal collected by the error microphone, and the (k−1)^{th}-frame filter coefficient of the target SP.

When the headset includes the first FF filter, the headset may further include an FB filter, or may not include the FB filter. In addition, the headset may further include at least one second FF filter, and a filter coefficient of each second FF filter is fixed at a same noise canceling level. In different cases, manners of determining the k^{th}-frame filter coefficient of the first FF filter are different. The manners are separately described below.

In a first case, the headset does not include the FB filter and the at least one second FF filter. In this case, k^{th}-frame frequency response information of the first FF filter is determined based on the (k−1)^{th}-frame reference signal collected by the at least one first reference microphone, the (k−1)^{th}-frame error signal collected by the error microphone, and the (k−1)^{th}-frame filter coefficient of the target SP. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, and the residual error.

In some embodiments, the at least one first reference microphone includes one reference microphone. In other words, the first FF filter corresponds to one reference microphone. In this case, the residual error is determined based on the (k−1)^{th}-frame reference signal collected by the reference microphone and the (k−1)^{th}-frame error signal collected by the error microphone.

In some other embodiments, the at least one first reference microphone includes at least two reference microphones. In other words, the first FF filter corresponds to at least two reference microphones. In this case, audio mixing is performed on (k−1)^{th}-frame reference signals collected by the at least two reference microphones, to obtain a (k−1)^{th}-frame mixed reference signal. The residual error is determined based on the (k−1)^{th}-frame mixed reference signal and the (k−1)^{th}-frame error signal collected by the error microphone. In this way, a signal-to-noise ratio of a reference signal can be improved.

An implementation process of determining the k^{th}-frame filter coefficient of the first FF filter based on the k^{th}-frame frequency response information of the first FF filter includes: establishing a loss function between a filter coefficient variable of the first FF filter and the k^{th}-frame frequency response information of the first FF filter. A value of the filter coefficient variable is determined based on the loss function according to a gradient descent method, and the k^{th}-frame filter coefficient of the first FF filter is determined based on the value of the filter coefficient variable. In other words, the loss function between the filter coefficient variable of the first FF filter and the k^{th}-frame frequency response information of the first FF filter is established. An optimal value of the variable is determined according to the gradient descent method, so that the k^{th}-frame filter coefficient of the first FF filter is determined based on the optimal value of the variable.

A filter coefficient of the first FF filter in each frame is determined according to the gradient descent method. One value of the loss function is determined when the filter coefficient of the first FF filter in each frame is determined. When the value of the loss function reaches a minimum threshold, it is determined that a filter coefficient of the first FF filter reaches a convergence stability condition. For example, for the k^{th}-frame filter coefficient of the first FF filter, when the value of the loss function between the filter coefficient variable and the k^{th}-frame frequency response information of the first FF filter reaches the minimum threshold, it is determined that the k^{th}-frame filter coefficient of the first FF filter reaches the convergence stability condition. When the value of the loss function does not reach the minimum threshold, it is determined that the k^{th}-frame filter coefficient of the first FF filter does not reach the convergence stability condition. The minimum threshold is preset, and may be adjusted based on different requirements in different cases.

Optionally, a filter coefficient of each FF filter includes at least one biquad filter coefficient and one gain. Variables corresponding to the biquad filter coefficient include a filter type, a cut-off frequency, and a quality factor. Certainly, in actual application, the filter coefficient of each FF filter may further include more or fewer other parameters. This is not limited in embodiments of this application.

In some cases, there is a problem of background noise, namely, noise floor, in a quiet environment. For example, for a semi-open headset, the headset is more likely to have a background noise problem in a quiet environment than an in-ear headset. In addition, strong noise cancellation is not required in the quiet environment, and some people may feel uncomfortable when strong noise cancellation is performed in the quiet environment. In addition, larger noise cancellation strength indicates a stronger negative pressure feeling of a person. Therefore, when the value of the filter coefficient variable is determined according to the gradient descent method, a target noise cancellation amplitude may be dynamically adjusted based on an environmental volume, so that the k^{th}-frame filter coefficient of the first FF filter is determined based on the target noise cancellation amplitude, to improve subjective experience effect of adaptive noise cancellation. In other words, the target noise cancellation amplitude is determined based on a (k−1)^{th}-frame environmental volume and environmental volumes in t frames before a (k−1)^{th} frame, where t is greater than or equal to 1 and less than k−1. The value of the filter coefficient variable is determined based on the target noise cancellation amplitude and the loss function according to the gradient descent method, and the k^{th}-frame filter coefficient of the first FF filter is determined based on the value of the filter coefficient variable.

In a second case, the headset further includes the one FB filter, but does not include the at least one second FF filter. In this case, the k^{th}-frame filter coefficient of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and a (k−1)^{th}-frame filter coefficient of the FB filter.

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and the (k−1)^{th}-frame filter coefficient of the FB filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, and the (k−1)^{th}-frame filter coefficient of the FB filter.

In a third case, the headset does not include the FB filter, but includes the at least one second FF filter. In this case, the k^{th}-frame filter coefficient of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and (k−1)^{th}-frame frequency response information of the at least one second FF filter.

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and the (k−1)^{th}-frame frequency response information of the at least one second FF filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, and the (k−1)^{th}-frame frequency response information of the at least one second FF filter.

In a fourth case, the headset includes the FB filter and the at least one second FF filter. In this case, the k^{th}-frame filter coefficient of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, a (k−1)^{th}-frame filter coefficient of the FB filter, and (k−1)^{th}-frame frequency response information of the at least one second FF filter

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, the (k−1)^{th}-frame filter coefficient of the FB filter, and the (k−1)^{th}-frame frequency response information of the at least one second FF filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, the (k−1)^{th}-frame filter coefficient of the FB filter, and the (k−1)^{th}-frame frequency response information of the at least one second FF filter.

In the foregoing processes of determining the k^{th}-frame frequency response information of the first FF filter, regardless of whether the headset includes an FB filter, the k^{th}-frame frequency response information of the first FF filter is determined based on the (k−1)^{th}-frame filter coefficient of the target SP, and the (k−1)^{th}-frame filter coefficient of the target SP is determined based on the target noise canceling level by querying the mapping relationship between the noise canceling level and the filter coefficient of the SP. To be specific, the (k−1)^{th}-frame filter coefficient of the target SP is an estimated value, and the k^{th}-frame frequency response information of the first FF filter is determined based on the estimated value, so that dependence on a real value of the target SP can be eliminated, and adaptation of a filter coefficient of an FF filter can also be implemented even when there is no downlink signal.

(2) Determine the k^{th}-Frame Filter Coefficient of the FB Filter.

When k is equal to 1, an initial filter coefficient of the FB filter is determined as the k^{th}-frame filter coefficient of the FB filter, that is, a first-frame filter coefficient of the FB filter is the initial filter coefficient of the FB filter, or the k^{th}-frame filter coefficient of the FB filter is determined based on an initial noise canceling level and a mapping relationship between a noise canceling level and an FB filter coefficient. When k is greater than 1, the k^{th}-frame filter coefficient of the FB filter may be determined based on the target noise canceling level. The initial noise cancellation coefficient includes the initial filter coefficient of the FB filter, and the initial filter coefficient may or may not be 0. This is not limited in embodiments of this application.

When k is greater than 1, the k^{th}-frame filter coefficient of the FB filter may be determined in the following two manners.

In a first manner, the k^{th}-frame filter coefficient of the FB filter is determined based on the target noise canceling level and the mapping relationship between the noise canceling level and the FB filter coefficient.

Because the mapping relationship between the noise canceling level and the FB filter coefficient is stored in advance, determining the k^{th}-frame filter coefficient of the FB filter in the first manner is stable, an operation is simple, and efficiency is high.

In a second manner, the k^{th}-frame filter coefficient of the FB filter is determined based on the (k−1)^{th}-frame error signal collected by the error microphone, a (k−1)^{th}-frame filter coefficient of the FB filter, and the target noise canceling level.

The first-frame filter coefficient of the FB filter may be determined based on the initial noise canceling level by querying the mapping relationship between the noise canceling level and the FB filter coefficient. Therefore, when k is greater than or equal to 1, it is equivalent to that the k^{th}-frame filter coefficient of the FB filter may be determined in two manners: (1) The k^{th}-frame filter coefficient of the FB filter is determined by querying the mapping relationship between the noise canceling level and the FB filter coefficient. (2) If k is equal to 1, the k^{th}-frame filter coefficient of the FB filter is determined by querying the mapping relationship between the noise canceling level and the FB filter coefficient. If k is greater than 1, the k^{th}-frame filter coefficient of the FB filter is determined based on the (k−1)^{h}-frame error signal collected by the error microphone, the (k−1)^{th}-frame filter coefficient of the FB filter, and the target noise canceling level.

An implementation process of determining the k^{th}-frame filter coefficient of the FB filter based on the (k−1)^{th}-frame error signal collected by the error microphone, the (k−1)^{th}-frame filter coefficient of the FB filter, and the target noise canceling level includes: determining a (k−1)^{th}-frame filter coefficient of a target SP based on the target noise canceling level and a mapping relationship between a noise canceling level and a filter coefficient of an SP, where the target SP is a path from the target speaker to the error microphone; and determining the k^{th}-frame filter coefficient of the FB filter based on the (k−1)^{th}-frame error signal collected by the error microphone, the (k−1)^{th}-frame filter coefficient of the FB filter, and the (k−1)^{th}-frame filter coefficient of the target SP.

In the foregoing second manner, a manner of querying the mapping relationship between the noise canceling level and the FB filter coefficient is combined with an adaptive manner, so that noise cancellation effect can be improved, complexity is not high, and stability is controllable.

It should be noted that, in embodiments of this application, the k^{th}-frame filter coefficient of the FB filter may be determined in the foregoing two manners, and the k^{th}-frame filter coefficient of the FB filter may alternatively be determined in another manner. For example, regardless of whether k is greater than 1 or equal to 1, the k^{th}-frame filter coefficient of the FB filter is determined based on the (k−1)^{th}-frame error signal collected by the error microphone, the (k−1)^{th}-frame filter coefficient of the FB filter, and the target noise canceling level. This is not limited in embodiments of this application.

(3) Determine the k^{th}-Frame Filter Coefficient of the Downlink Compensation Filter.

When k is equal to 1, an initial filter coefficient of the downlink compensation filter is determined as the k^{th}-frame filter coefficient of the downlink compensation filter, or the k^{th}-frame filter coefficient of the downlink compensation filter is determined based on an initial noise canceling level and a mapping relationship between a noise canceling level and a downlink compensation filter coefficient. When k is greater than 1, the k^{th}-frame filter coefficient of the downlink compensation filter is determined based on the target noise canceling level and the mapping relationship between the noise canceling level and the downlink compensation filter coefficient.

The mapping relationship between the noise canceling level and the downlink compensation filter coefficient includes a plurality of noise canceling levels, a mapping relationship exists between each noise canceling level and a filter coefficient of the downlink compensation filter, and mapping relationships between different noise canceling levels and filter coefficients of the downlink compensation filter may be different. Therefore, after the target noise canceling level is determined, a corresponding downlink compensation filter coefficient can be obtained from the mapping relationship between the noise canceling level and the downlink compensation filter coefficient based on the target noise canceling level, and the obtained downlink compensation filter coefficient is used as the k^{th}-frame filter coefficient of the downlink compensation filter.

### (4) Determine the Target Noise Canceling Level.

A (k−1)^{th}-frame noise canceling level is determined, and noise canceling levels in m frames before a (k−1)^{th} frame are obtained, where m is greater than or equal to 1 and less than k−1. The target noise canceling level is determined based on the (k−1)^{th}-frame noise canceling level and the noise canceling levels in the m frames.

In the (k−1)^{th} frame, a valid downlink signal may exist, or no valid downlink signal may exist, and an environment may be quiet, or an environment may not be quiet, or certainly, an abnormal signal may exist. In different cases, manners of determining the (k−1)^{th}-frame noise canceling level are different, and are separately described below.

In a first case, in the (k−1)^{th} frame, no valid downlink signal exists and the environment is not quiet. In this case, the (k−1)^{th}-frame noise canceling level is determined based on a reference filter coefficient of the first FF filter and a mapping relationship between a noise canceling level and frequency response information of the first FF filter. When k is equal to 2, the reference filter coefficient is an initial filter coefficient of the first FF filter; or when k is greater than 2, the reference filter coefficient is a filter coefficient that is of the first FF filters and that meets a convergence stability condition last time before a k^{th} frame, or is a (k−1)^{th}-frame filter coefficient of the first FF filter.

In some embodiments, reference frequency response information of the first FF filter is determined based on the reference filter coefficient of the first FF filter. A noise canceling level matching the reference frequency response information of the first FF filter is determined based on the mapping relationship between the noise canceling level and the frequency response information of the first FF filter, to obtain the (k−1)^{th}-frame noise canceling level.

In a second case, the valid downlink signal exists in the (k−1)^{th} frame. In this case, the (k−1)^{th}-frame noise canceling level is determined based on the (k−1)^{th}-frame valid downlink signal, a (k−1)^{th}-frame reference signal collected by the at least one first reference microphone, and a (k−1)^{th}-frame error signal collected by the error microphone.

In view of the foregoing descriptions, when the headset is in a downlink enabled state and is not in a downlink intermittent period, it is determined that the valid downlink signal exists in the (k−1)^{th} frame. In this case, a valid downlink signal may be extracted from the (k−1)^{th}-frame error signal collected by the error microphone based on the (k−1)^{th}-frame valid downlink signal, the (k−1)^{th}-frame reference signal collected by the at least one first reference microphone, and the (k−1)^{th}-frame error signal collected by the error microphone, to determine the (k−1)^{th}-frame noise canceling level based on the extracted valid downlink signal.

In a third case, in the (k−1)^{th} frame, no valid downlink signal exists and the environment is quiet, or the abnormal noise signal exists in the (k−1)^{th} frame. In this case, a (k−3)^{th}-frame noise canceling level is determined as the (k−1)^{th}-frame noise canceling level. In other words, the noise canceling level remains unchanged.

In the (k−1)^{th} frame, when no valid downlink signal exists and the environment is quiet, noise basically does not change. In this case, the noise canceling level may remain unchanged. When the abnormal noise signal exists in the (k−1)^{th} frame, the noise canceling level remains unchanged, to perform robustness control, and avoid divergence of the noise canceling level.

After the (k−1)^{th}-frame noise canceling level is determined in the foregoing three cases, the (k−1)^{th}-frame noise canceling level and the noise canceling levels in the m frames before the (k−1)^{th} frame may be integrated, to determine the target noise canceling level.

The noise canceling levels in the m frames may be noise canceling levels in any m frames before the (k−1)^{th} frame, or may be noise canceling levels in m frames that are before the (k−1)^{th} frame and that are closest to the (k−1)^{th} frame. This is not limited in embodiments of this application. In addition, there are a plurality of implementations of determining the target noise canceling level based on the (k−1)^{th}-frame noise canceling level and the noise canceling levels in the m frames before the (k−1)^{th} frame. For example, noise cancellation effect is evaluated according to a related algorithm, to determine a noise cancellation probability corresponding to the (k−1)^{th}-frame noise canceling level and noise cancellation probabilities corresponding to the noise canceling levels in the m frames, and determine a noise canceling level with a largest noise cancellation probability as the target noise canceling level. Alternatively, an arithmetic average value or a weighted average value of the (k−1)^{th}-frame noise canceling level and the noise canceling levels in the m frames is determined, to obtain the target noise canceling level. Alternatively, a noise canceling level that appears most frequently in the (k−1)^{th}-frame noise canceling level and the noise canceling levels in the m frames is determined as the target noise canceling level, or the like.

Target inverse phase noise is generated based on the target noise cancellation parameter, and noise cancellation is performed through the target speaker in the at least one speaker based on the target inverse phase noise.

When the target noise cancellation parameter includes the k^{th}-frame filter coefficient of the first FF filter, the target inverse phase noise includes feedforward inverse phase noise. In this case, a k^{th}-frame reference signal collected by the at least one first reference microphone may be processed based on the k^{th}-frame filter coefficient of the first FF filter, to obtain the feedforward inverse phase noise.

In view of the foregoing descriptions, the at least one first reference microphone may include one reference microphone, or may include at least two reference microphones. When the at least one first reference microphone includes one reference microphone, the k^{th}-frame reference signal collected by the reference microphone may be processed directly based on the k^{th}-frame filter coefficient of the first FF filter, to obtain the feedforward inverse phase noise. When the at least one first reference microphone includes at least two reference microphones, audio mixing is performed on k^{th}-frame reference signals collected by the at least two reference microphones, to obtain a k^{th}-frame mixed reference signal, and then the k^{th}-frame mixed reference signal is processed based on the k^{th}-frame filter coefficient of the first FF filter, to obtain the feedforward inverse phase noise.

Optionally, the headset may further include at least one second FF filter. In this case, a k^{th}-frame filter coefficient of the at least one second FF filter may be determined. Noise cancellation is performed through the target speaker based on the target noise cancellation parameter and the k^{th}-frame filter coefficient of the at least one second FF filter. In other words, the k^{th}-frame reference signal collected by the at least one first reference microphone is processed based on the k^{th}-frame filter coefficient of the first FF filter, to obtain first feedforward inverse phase noise. The k^{th}-frame reference signal collected by the at least one first reference microphone is processed based on the k^{th}-frame filter coefficient of the at least one second FF filter, to obtain at least one second feedforward inverse phase noise.

When k is equal to 1, an initial filter coefficient of the at least one second FF filter is determined as the k^{th}-frame filter coefficient of the at least one second FF filter, that is, a first-frame filter coefficient of the at least one second FF filter is the initial filter coefficient of the corresponding second FF filter, or the k^{th}-frame filter coefficient of the at least one second FF filter is determined based on an initial noise canceling level and a mapping relationship between a noise canceling level and a second FF filter coefficient. When k is greater than 1, the k^{th}-frame filter coefficient of the at least one second FF filter is determined based on the target noise canceling level and the mapping relationship between the noise canceling level and the second FF filter coefficient. The initial noise cancellation coefficient includes the initial filter coefficient of the at least one second FF filter, and the initial filter coefficient may be equal to 0 or may not be 0. This is not limited in embodiments of this application.

The foregoing descriptions are provided by using an example in which both the first FF filter and the at least one second FF filter correspond to the at least one first reference microphone. In actual application, the first FF filter and the at least one second FF filter may alternatively correspond to different reference microphones. For example, the headset further includes a plurality of second reference microphones, the first FF filter corresponds to at least one first reference microphone, and each second FF filter corresponds to at least one second reference microphone in the plurality of second reference microphones. In this case, the k^{th}-frame reference signal collected by the at least one first reference microphone may be processed based on the k^{th}-frame filter coefficient of the first FF filter, to obtain the first feedforward inverse phase noise. A k^{th}-frame reference signal collected by the at least one second reference microphone corresponding to each second FF filter is processed based on a k^{th}-frame filter coefficient of each second FF filter, to obtain the at least one second feedforward inverse phase noise.

When the headset further includes an FB filter, the target inverse phase noise further includes feedback inverse phase noise. In other words, downlink compensation is performed on a k^{th}-frame downlink signal sent by a user terminal. In other words, downlink compensation is performed, based on the k^{h}-frame filter coefficient of the downlink compensation filter, on the k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The k^{th}-frame noise signal collected by the error microphone is processed based on the k^{th}-frame filter coefficient of the FB filter, to obtain the feedback inverse phase noise.

Downlink compensation can be used to remove all downlink signals in error signals collected by the error microphone, so that noise cancellation is performed only on a residual noise signal through the FB filter, to avoid a sound quality damage to the downlink signals. In addition, downlink compensation is performed on the k^{th}-frame downlink signal sent by the user terminal, so that downlink signals of all speakers at the error microphone can be removed, to avoid a sound quality damage to full-band downlink signals.

In view of the foregoing descriptions, when the target noise cancellation parameter is determined on a per-frame basis, because one frame may include one sample point, or may include a plurality of sample points, when the target inverse phase noise is generated, a group of target inverse phase noise may be generated at each sample point, or a group of target inverse phase noise may be generated in one frame.

In embodiments of this application, when the target noise cancellation parameter is determined, frequency division is not performed on the downlink signals, that is, the target noise cancellation parameter is determined based on full-band downlink signals. In this way, after the target inverse phase noise is generated based on the target noise cancellation parameter, a frequency band of the target inverse phase noise covers a sound-making frequency band of the at least one speaker, that is, the frequency band of the target inverse phase noise is a full frequency band.

After the target inverse phase noise is generated, the target inverse phase noise is mixed with a k^{th}-frame downlink signal to be played through the target speaker, and then a mixed signal is played through the target speaker, to achieve noise cancellation.

The at least one speaker may include one speaker, or may include a plurality of speakers. When the at least one speaker includes one speaker, the speaker may be a full-band speaker. When the at least one speaker includes a plurality of speakers, some of the plurality of speakers may be high-band speakers, and the other may be low-band speakers. Alternatively, some of the plurality of first speakers are full-band speakers, and the other are non-full-band speakers. In other words, sound-making frequency bands of the plurality of speakers may be different. Alternatively, the plurality of speakers are all full-band speakers. Alternatively, the plurality of speakers are all non-full-band speakers. When the plurality of speakers are all the full-band speakers, the k^{th}-frame downlink signals to be played through the plurality of speakers are all the k^{th}-frame downlink signal sent by the user terminal. When not all of the plurality of speakers are full-band speakers, frequency division needs to be performed, based on a sound-making frequency band of each speaker, on the k^{th}-frame downlink signal sent by the user terminal, to obtain a k^{th}-frame downlink signal to be played through each speaker.

In embodiments of this application, noise cancellation is performed through the target speaker in the at least one speaker. When the at least one speaker includes one speaker, the speaker is the target speaker. When the at least one speaker includes a plurality of speakers, and the plurality of speakers include a first speaker and a second speaker on which digital frequency division is performed, the target speaker is the first speaker, and the second speaker does not participate in noise cancellation. However, the second speaker may participate in downlink compensation (that is, downlink compensation is performed on a downlink signal sent by the user terminal, where the downlink signal is a full-band audio signal, including an audio signal at a sound-making frequency band of the second speaker). In this case, the first speaker may be a low- and medium-band speaker, or may be a full-band speaker, and the second speaker may be a high-band speaker, or may be a medium-band speaker or a low-band speaker. Optionally, the second speaker may not participate in downlink compensation. In this case, the first speaker may be the low- and medium-band speaker, or may be the full-band speaker, and the second speaker is the high-band speaker.

Optionally, the at least one speaker may alternatively include a first speaker and a second speaker on which analog frequency division is performed. In this case, the target speaker is the first speaker and the second speaker, that is, both the first speaker and the second speaker participate in noise cancellation.

When the target speaker is the first speaker and the second speaker, the first speaker and the second speaker may be an analog frequency division combination of the two speakers. In other words, the first speaker and the second speaker are driven by using a same DAC and PA, and the combination of the first speaker and the second speaker may be considered as one speaker.

The foregoing process of determining the target noise cancellation parameter according to the adaptation method requires specific time, and when one frame includes a plurality of sample points and duration of the one frame is long, duration of determining the target noise cancellation parameter is less than the duration of the one frame. Therefore, calculation may be performed in a part of a time period of the k^{th} frame based on related data of the (k−1)^{th} frame, to obtain a k^{th}-frame target noise cancellation parameter, and perform active noise cancellation in the other part of the time period of the k^{th} frame based on the k^{th}-frame target noise cancellation parameter. However, when the one frame includes one sample point, or the one frame includes a plurality of sample points and the duration of the one frame is short, the duration of determining the target noise cancellation parameter may be equal to the duration of the one frame. In this case, calculation may need to be performed in the entire time period of the k^{th} frame based on the related data of the (k−1)^{th} frame, to obtain the target noise cancellation parameter. In this case, the target noise cancellation parameter may be determined as a (k+1)^{th}-frame target noise cancellation parameter, and then active noise cancellation is performed in a time period of a (k+1)^{th} frame based on the (k+1)^{th}-frame target noise cancellation parameter. The foregoing content is described by using the later case as an example.

According to a second aspect, a headset is provided. The headset includes at least one first reference microphone, one error microphone, at least one speaker, one first feedforward FF filter, and one noise cancellation processor.

The noise cancellation processor is configured to implement steps of the method according to the first aspect.

Optionally, the at least one speaker includes a first speaker and a second speaker on which digital frequency division is performed, the target speaker is the first speaker, and the second speaker does not participate in noise cancellation.

Optionally, the second speaker participates in downlink compensation.

Optionally, the second speaker does not participate in downlink compensation, and the second speaker is a high-band speaker.

Optionally, the at least one speaker includes a first speaker and a second speaker on which analog frequency division is performed, and the target speaker is the first speaker and the second speaker.

Optionally, the headset further includes at least one second FF filter, and a filter coefficient of the second FF filter is fixed at a same noise canceling level.

Optionally, the headset further includes a plurality of second reference microphones, the first FF filter corresponds to the at least one first reference microphone, and each of the at least one second FF filter corresponds to at least one second reference microphone in the plurality of second reference microphones.

According to a third aspect, a noise cancellation apparatus is provided. The noise cancellation apparatus has a function of implementing a behavior of the noise cancellation method in the first aspect. The noise cancellation apparatus includes one or more modules, and the one or more modules are configured to implement the noise cancellation method provided in the first aspect.

According to a fourth aspect, a computer-readable storage medium is provided. The computer-readable storage medium stores instructions. When the instructions are run on a computer, the computer is enabled to perform the noise cancellation method described in the first aspect.

According to a fifth aspect, a computer program product that includes instructions is provided. When the instructions are run on a computer, the computer is enabled to perform the noise cancellation method described in the first aspect.

Technical effect obtained in the second aspect to the fifth aspect is similar to technical effect obtained by the corresponding technical means in the first aspect. Details are not described herein again.

### BRIEF DESCRIPTION OF DRAWINGS

FIG. 1 is a diagram of a system architecture related to a noise cancellation method according to an embodiment of this application;

FIG. 2 is a flowchart of a noise cancellation method according to an embodiment of this application;

FIG. 3 is a flowchart of determining a target noise cancellation amplitude according to an embodiment of this application;

FIG. 4 is a diagram of frequency response curves of an FF filter at 16 noise canceling levels according to an embodiment of this application;

FIG. 5 is a flowchart of determining a (k−1)^{th}-frame noise canceling level according to an embodiment of this application;

FIG. 6 is a flowchart of determining a target noise cancellation parameter according to an embodiment of this application;

FIG. 7 is a diagram of a structure of a headset according to an embodiment of this application;

FIG. 8 is a diagram of a structure of another headset according to an embodiment of this application;

FIG. 9 is a diagram of a structure of another headset according to an embodiment of this application;

FIG. 10 is a diagram of a structure of another headset according to an embodiment of this application;

FIG. 11 is a diagram of a structure of another headset according to an embodiment of this application;

FIG. 12 is a diagram of a structure of another headset according to an embodiment of this application;

FIG. 13 is a diagram of a structure of a noise cancellation apparatus according to an embodiment of this application; and

FIG. 14 is a diagram of a structure of another headset according to an embodiment of this application.

### DESCRIPTION OF EMBODIMENTS

To make the objectives, technical solutions, and advantages of this application clearer, the following further describes the implementations of this application in detail with reference to the accompanying drawings.

Active noise cancellation headsets are popular in recent years. Traditional noise cancellation headsets are generally in-ear or head-mounted. The reason is that in the two forms, the headset and an ear canal are well sealed, and acoustic leakage is stable when different people wear the headset. This can implement active noise cancellation technically, and has better effect. Therefore, a noise cancellation mode with a fixed coefficient is generally used. However, the two types of headsets also have some disadvantages. For example, sealing between the headset and the ear canal is too good, which affects subjective comfort of people, typically characterized by a foreign body sensation and a sense of closure under conditions such as walking. It is difficult to wear for a long time.

Semi-open headsets are widely accepted by users due to their good comfort. However, in a semi-open form, environment noise is more likely to be felt by people because the headset and the human ear are not well sealed. It is more challenging to implement active noise cancellation in the semi-open headset. The reason is that when different people wear the headset, even when a same person wears the headset different times, wearing postures are greatly different. Technically, response functions and acoustic leakage degrees between the headset and an ear canal are greatly different. Therefore, how to implement adaptive noise cancellation to cope with a problem of differentiation of ear canal responses, and implement optimal matching between a headset and an ear canal is an urgent requirement in the semi-open form. In addition, even in an in-ear form or a head-mounted form, ear canal responses are not absolutely consistent, and there is still a large or small difference. Currently, the industry is also exploring feasibility of adaptive noise cancellation of headsets.

As mentioned above, the headsets have a plurality of forms, such as an in-ear form, a head-mounted form, a semi-open form, and an open form. Audio performance, especially performance in a low frequency, of a speaker (namely, a loudspeaker) in an entire headset is closely related to a specific form of the headset. In a sealed form like the in-ear form or the head-mounted form, audio performance in high, medium, and low frequencies is generally ensured. In the semi-open form or the open form, due to severe acoustic leakage, a low-band response drops greatly. This affects performance of low-band sound quality, and seriously affects active noise cancellation effect (which is insufficient to generate inverse phase noise with sufficient energy).

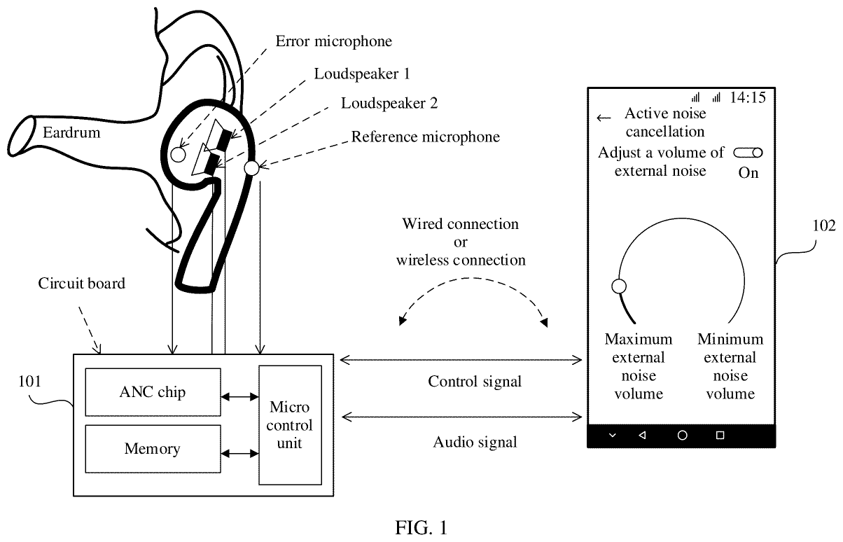

In view of the foregoing problems, embodiments of this application provide a noise cancellation method, to implement adaptive active noise cancellation (active noise cancellation, ANC) of a headset. Refer to FIG. 1. FIG. 1 is a diagram of a system architecture related to a noise cancellation method according to an embodiment of this application. The system may be referred to as a headset noise cancellation system. The system includes a headset 101 and a user terminal 102. The headset 101 and the user terminal 102 are connected in a wired or wireless manner to perform communication. For example, the headset 101 communicates with the user terminal 102 through Bluetooth or through another wireless network.

An audio signal and a control signal can be transmitted between the headset 101 and the user terminal 102. For example, the user terminal 102 sends an audio signal like music or a voice to the headset 101 for playing. For another example, the user terminal 102 sends a control signal to the headset 101, to control whether an active noise cancellation function of the headset 101 is enabled, or the like.

The user terminal 102 may be an electronic device like a mobile phone or a computer (for example, a notebook computer, a desktop computer, a handheld tablet computer, or a vehicle-mounted tablet computer). The user terminal 102 may alternatively be another electronic device, for example, a smart speaker or a vehicle-mounted speaker. A type, a structure, and the like of the user terminal 102 are not limited in embodiments of this application.

Optionally, the headset 101 provided in embodiments of this application may be wired or wireless. In addition, from a perspective of a wearing manner, the headset 101 provided in embodiments of this application may be of a neck-mounted type, an ear-mounted/ear-clip type, a true wireless stereo (TWS) type, or the like. From a perspective of an appearance, the headset 101 provided in embodiments of this application may be of an in-ear type, a semi-open type, an open type, a head-mounted type, or the like. A communication manner, the wearing manner, and the appearance of the headset are not limited in embodiments of this application. The following describes, with reference to the wearing manner of the headset in a human ear, a hardware structure of the headset provided in embodiments of this application.

As shown in FIG. 1, the headset 101 includes at least one speaker (namely, a loudspeaker), a plurality of microphones, a micro control unit (MCU), an ANC chip, and a memory. The at least one speaker includes a target speaker, and the target loudspeaker indicates a speaker participating in noise cancellation, for example, a loudspeaker 1. The target speaker may be a first speaker, and the first speaker needs to participate in noise cancellation. For example, the first speaker is a low- and medium-band speaker, and the low- and medium-band speaker needs to participate in noise cancellation. Optionally, the at least one speaker further includes a second speaker, and the second speaker does not participate in noise cancellation. For example, the second speaker is a high-band speaker, and the high-band speaker does not need to participate in noise cancellation. Certainly, for any speaker, regardless of whether the speaker is a high-band speaker or a low- and medium-band speaker, the speaker may participate in noise cancellation or may not participate in noise cancellation. In other words, in embodiments of this application, a sound-making frequency band of the first speakers participating in noise cancellation is not limited, and a sound-making frequency band of the second speaker not participating in noise cancellation is not limited. For example, the target speaker is the first speaker and the second speaker. The plurality of microphones include at least one reference microphone and one error microphone. FIG. 1 is described by using one reference microphone as an example.

A speaker is configured to play a downlink signal (for example, an audio signal like music or a voice). The at least one speaker is driven by using an independent digital to analog converter (DAC) and a power amplifier (PA). In other words, one speaker corresponds to one DAC and one PA, and different speakers correspond to different DACs and PAs. Certainly, the at least one speaker may alternatively be driven by using a same DAC and PA, or some speakers in the at least one speaker are driven by using a same DAC and PA, and the other speakers are driven by using another DAC and PA. In a noise cancellation process, the target speaker is further configured to play inverse phase noise, where the inverse phase noise is used to reduce a noise signal in an ear canal of a user, to achieve active noise cancellation effect.

The reference microphone is deployed outside the headset. After the headset is worn to a human ear, the reference microphone is located outside the human ear. The reference microphone is configured to collect a noise signal of an external environment. In embodiments of this application, the noise signal collected by the reference microphone is referred to as a reference signal.

The error microphone is deployed inside the headset. After the headset is worn to the human ear, the error microphone is located inside the human ear. The error microphone is configured to collect a noise signal in the ear canal. In embodiments of this application, the noise signal collected by the error microphone is referred to as an error signal.

The micro control unit is configured to process the reference signal collected by the reference microphone, the error signal collected by the error microphone, a downlink signal, and the like, to determine a target noise cancellation parameter, and write the target noise cancellation parameter into the ANC chip.

The ANC chip is configured to process, based on the target noise cancellation parameter, the reference signal collected by the reference microphone and the error signal collected by the error microphone, to generate inverse phase noise, perform audio mixing on the generated inverse phase noise and a downlink signal to be played through a speaker, and output a mixed signal to the corresponding speaker, so as to reduce a noise signal in the ear canal.

The memory is configured to store an initial parameter, a mapping relationship, and the like that are used when the target noise cancellation parameter is determined.

It should be noted that the micro control unit, the ANC chip, and the memory may be integrated on a same circuit board, or may be deployed on different circuit boards. This is not limited in embodiments of this application. In addition, the micro control unit and the ANC chip are merely distinguished in terms of logical function descriptions. In an actual physical form, the micro control unit and the ANC chip may be integrated into one chip, or may be separately deployed on a plurality of chips. For example, the micro control unit and the ANC chip are deployed on two chips.

Optionally, the headset 101 may further include another element, for example, an optical proximity sensor, configured to detect whether the headset 101 is in the ear. If the headset 101 is a wireless headset, the headset 101 may further include a wireless communication module, and the wireless communication module may be a wireless local area network module or a Bluetooth module. The wireless communication module is used by the headset 101 to communicate with another device.

It may be understood that the schematic structure in embodiments of this application does not constitute a limitation on the headset. In some other embodiments, the headset 101 may include more or fewer components than those shown in the figure, or some components may be combined, or some components may be split, or there may be a different component arrangement. The components shown in the figure may be implemented by using hardware, software, or a combination of software and hardware.

The system architecture and a service scenario described in embodiments of this application are intended to describe the technical solutions in embodiments of this application more clearly, and do not constitute a limitation on the technical solutions provided in embodiments of this application. A person of ordinary skill in the art may know that: With the evolution of the system architecture and the emergence of new service scenarios, the technical solutions provided in embodiments of this application are also applicable to similar technical problems.

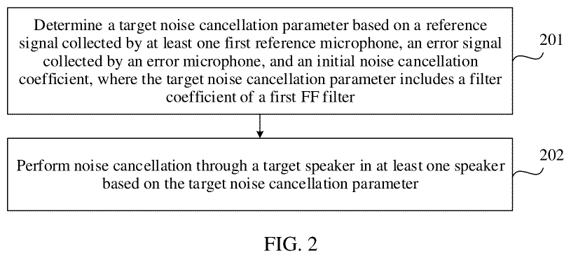

FIG. 2 is a flowchart of a noise cancellation method according to an embodiment of this application. The method is applied to a headset, and the headset includes at least one first reference microphone, one error microphone, at least one first speaker, and one first FF filter. Refer to FIG. 2. The method includes the following steps.

Step 201: Determine a target noise cancellation parameter based on a reference signal collected by the at least one first reference microphone, an error signal collected by the error microphone, and an initial noise cancellation coefficient, where the target noise cancellation parameter includes a filter coefficient of the first FF filter.

According to the noise cancellation method provided in embodiments of this application, the target noise cancellation parameter can be determined on a per-frame basis. In other words, a group of target noise cancellation parameters are determined in each frame. Certainly, the target noise cancellation parameter can alternatively be determined in another time unit. For example, a group of target noise cancellation parameters are determined in every two frames. The following uses a frame as a unit for description.

When the headset includes the first FF filter, the target noise cancellation parameter includes a k^{th}-frame filter coefficient of the first FF filter, where k is an integer greater than or equal to 1. In some cases, the headset further includes an FB filter. In this case, the target noise cancellation parameter further includes a k^{th}-frame filter coefficient of the FB filter. In addition, when the headset further includes a downlink compensation filter, the plurality of groups of target noise cancellation parameters further include a k^{th}-frame filter coefficient of the downlink compensation filter. In addition, when k is greater than 1, a target noise canceling level may be further determined. Therefore, the following separately describes the four parts.

(1) Determine the k^{th}-Frame Filter Coefficient of the First FF Filter.

When k is equal to 1, an initial filter coefficient of the first FF filter is determined as the k^{th}-frame filter coefficient of the first FF filter, that is, a first-frame filter coefficient of the first FF filter is the initial filter coefficient of the first FF filter, or the k^{th}-frame filter coefficient of the first FF filter is determined based on an initial noise canceling level and a mapping relationship between a noise canceling level and a first FF filter coefficient. When k is greater than 1, the k^{th}-frame filter coefficient of the first FF filter is determined based on a (k−1)^{th}-frame reference signal collected by the at least one first reference microphone, a (k−1)^{th}-frame error signal collected by the error microphone, and the target noise canceling level. In other words, the k^{th}-frame filter coefficient of the first FF filter is determined according to an adaptation method. The determining process is an adaptation process, and may also be referred to as an iteration process.

It should be noted that the initial noise cancellation coefficient includes an initial filter coefficient of the first FF filter, the initial filter coefficient of the first FF filter may be determined in advance, and the initial filter coefficient may or may not be 0. This is not limited in embodiments of this application. The initial noise canceling level may be a preset level, and the level is a level at which noise cancellation can be normally performed by using a corresponding noise cancellation coefficient without introducing a stability problem. Certainly, the initial noise canceling level may alternatively be a level determined based on a prompt tone like “Noise cancellation on” or “Dingdong” sent by a user terminal when noise cancellation starts. A noise cancellation coefficient corresponding to the level can better adapt to a current human ear and wearing posture, and a convergence state can be reached more quickly by performing adaptive iteration based on the noise cancellation coefficient corresponding to the level. This is also not limited in embodiments of this application.

An implementation process of determining the k^{th}-frame filter coefficient of the first FF filter based on the (k−1)^{th}-frame reference signal collected by the at least one first reference microphone, the (k−1)^{th}-frame error signal collected by the error microphone, and the target noise canceling level includes: determining a (k−1)^{th}-frame filter coefficient of a target SP based on the target noise canceling level and a mapping relationship between a noise canceling level and a filter coefficient of an SP, where the target SP is a path from the target speaker to the error microphone; and determining the k^{th}-frame filter coefficient of the first FF filter based on the (k−1)^{th}-frame reference signal collected by the at least one first reference microphone, the (k−1)^{th}-frame error signal collected by the error microphone, and the (k−1)^{th}-frame filter coefficient of the target SP.

The mapping relationship between the noise canceling level and the filter coefficient of the SP includes a plurality of noise canceling levels. A mapping relationship exists between each noise canceling level and the filter coefficient of the target SP, and mapping relationships between different noise canceling levels and the filter coefficient of the target SP may be different. Therefore, after the target noise canceling level is determined, the filter coefficient corresponding to the target SP can be obtained from the mapping relationship between the noise canceling level and the filter coefficient of the SP based on the target noise canceling level, and the obtained filter coefficient is used as the (k−1)^{th}-frame filter coefficient of the target SP.

When the headset includes the first FF filter, the headset may further include an FB filter, or may not include the FB filter. In addition, the headset may further include at least one second FF filter, and a filter coefficient of each second FF filter is fixed at a same noise canceling level. In different cases, manners of determining the k^{th}-frame filter coefficient of the first FF filter are different. The manners are separately described below.

In a first case, the headset does not include the FB filter and the at least one second FF filter. In this case, k^{th}-frame frequency response information of the first FF filter is determined based on the (k−1)^{th}-frame reference signal collected by the at least one first reference microphone, the (k−1)^{th}-frame error signal collected by the error microphone, and the (k−1)^{th}-frame filter coefficient of the target SP. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, and the residual error.

In some embodiments, the at least one first reference microphone includes one reference microphone. In other words, the first FF filter corresponds to one reference microphone. In this case, the residual error is determined according to the following formula (1) based on the (k−1)^{th}-frame reference signal collected by the reference microphone and the (k−1)^{th}-frame error signal collected by the error microphone.

$${Res}_{k - 1} = \frac{E r {r}_{k - 1}}{R e {f}_{k - 1}} \qquad ( 1 )$$

In the foregoing formula (1), Resₖ₋₁ indicates the residual error, Refₖ₋₁ indicates the (k−1)^{th}-frame reference signal collected by the reference microphone, and Errₖ₋₁, indicates the (k−1)^{th}-frame error signal collected by the error microphone.

In some other embodiments, the at least one first reference microphone includes at least two reference microphones. In other words, the first FF filter corresponds to at least two reference microphones. In this case, audio mixing is performed on (k−1)^{th}-frame reference signals collected by the at least two reference microphones, to obtain a (k−1)^{th}-frame mixed reference signal. The residual error is determined based on the (k−1)^{th}-frame mixed reference signal and the (k−1)^{th}-frame error signal collected by the error microphone. In this way, a signal-to-noise ratio of a reference signal can be improved.

A manner of determining the residual error based on the (k−1)^{th}-frame mixed reference signal and the (k−1)^{th}-frame error signal collected by the error microphone is similar to the foregoing manner of determining the residual error according to the foregoing formula (1). To be specific, the (k−1)^{th}-frame error signal collected by the error microphone is divided by the (k−1)^{th}-frame mixed reference signal, to obtain the residual error.

In some embodiments, frequency response information of the (k−1)^{th}-frame filter coefficient of the target SP may be determined, and then the k^{th}-frame frequency response information of the first FF filter is determined according to the following formula (2) based on the (k−1)^{th}-frame frequency response information of the first FF filter, the (k−1)^{th}-frame filter coefficient of the target SP, and the residual error.

$$F {F}_{k} = F {F}_{k - 1} + μ \frac{{Res}_{k - 1}}{S {P}_{k - 1}} \qquad ( 2 )$$

In the foregoing formula (2), FFₖ indicates the k^{th}-frame frequency response information of the first FF filter, FFₖ₋₁ indicates the (k−1)^{th}-frame frequency response information of the first FF filter, μ indicates a step and is preset, and SPₖ₋₁ indicates the frequency response information of the (k−1)^{th}-frame filter coefficient of the target SP.

An implementation process of determining the k^{th}-frame filter coefficient of the first FF filter based on the k^{th}-frame frequency response information of the first FF filter includes: establishing a loss function between a filter coefficient variable of the first FF filter and the k^{th}-frame frequency response information of the first FF filter. A value of the filter coefficient variable is determined based on the loss function according to a gradient descent method, and the k^{th}-frame filter coefficient of the first FF filter is determined based on the value of the filter coefficient variable. In other words, the loss function between the filter coefficient variable of the first FF filter and the k^{th}-frame frequency response information of the first FF filter is established. An optimal value of the variable is determined according to the gradient descent method, so that the k^{th}-frame filter coefficient of the first FF filter is determined based on the optimal value of the variable.

A filter coefficient of the first FF filter in each frame is determined according to the gradient descent method. One value of the loss function is determined when the filter coefficient of the first FF filter in each frame is determined. When the value of the loss function reaches a minimum threshold, it is determined that a filter coefficient of the first FF filter reaches a convergence stability condition. For example, for the k^{th}-frame filter coefficient of the first FF filter, when the value of the loss function between the filter coefficient variable and the k^{th}-frame frequency response information of the first FF filter reaches the minimum threshold, it is determined that the k^{th}-frame filter coefficient of the first FF filter reaches the convergence stability condition. When the value of the loss function does not reach the minimum threshold, it is determined that the k^{th}-frame filter coefficient of the first FF filter does not reach the convergence stability condition. The minimum threshold is preset, and may be adjusted based on different requirements in different cases.

Optionally, a filter coefficient of each FF filter includes at least one biquad filter coefficient and one gain. Variables corresponding to the biquad filter coefficient include a filter type, a cut-off frequency, and a quality factor. Certainly, in actual application, the filter coefficient of each FF filter may further include more or fewer other parameters. This is not limited in embodiments of this application.

The k^{th}-frame filter coefficient of the first FF filter may be determined according to a related algorithm based on the value of the filter coefficient variable. The algorithm is not limited in embodiments of this application.

In some cases, there is a problem of background noise, namely, noise floor, in a quiet environment. For example, for a semi-open headset, the headset is more likely to have a background noise problem in a quiet environment than an in-ear headset. In addition, strong noise cancellation is not required in the quiet environment, and some people may feel uncomfortable when strong noise cancellation is performed in the quiet environment. In addition, larger noise cancellation strength indicates a stronger negative pressure feeling of a person. Therefore, when the value of the filter coefficient variable is determined according to the gradient descent method, a target noise cancellation amplitude may be dynamically adjusted based on an environmental volume, so that the k^{th}-frame filter coefficient of the first FF filter is determined based on the target noise cancellation amplitude, to improve subjective experience effect of adaptive noise cancellation. In other words, the target noise cancellation amplitude is determined based on a (k−1)^{th}-frame environmental volume and environmental volumes in t frames before a (k−1)^{th} frame, where t is greater than or equal to 1 and less than k−1. The value of the filter coefficient variable is determined based on the target noise cancellation amplitude and the loss function according to the gradient descent method, and the k^{th}-frame filter coefficient of the first FF filter is determined based on the value of the filter coefficient variable.

A target environmental volume is determined based on the (k−1)^{th}-frame environmental volume and the environmental volumes in the t frames before the (k−1)^{th} frame. If the target environmental volume is less than or equal to a first volume threshold, a first noise cancellation amplitude is determined as the target noise cancellation amplitude. If the target environmental volume is greater than the first volume threshold, it is determined whether the target environmental volume is significantly increased or significantly decreased, and if the target environmental volume is significantly increased, a (k−1)^{th}-frame noise cancellation amplitude is increased, to obtain the target noise cancellation amplitude. If the target environmental volume is significantly decreased, the (k−1)^{th}-frame noise cancellation amplitude is decreased, to obtain the target noise cancellation amplitude. If the target environmental volume is not significantly increased and is not significantly decreased, the (k−1)^{th}-frame noise cancellation amplitude is determined as the target noise cancellation amplitude, that is, the noise cancellation amplitude remains unchanged.

There are a plurality of manners of determining the target environmental volume based on the (k−1)^{h}-frame environmental volume and the environmental volumes in the t frames before the (k−1)^{th} frame, for example, obtaining an arithmetic average value or a weighted average value. This is not limited in embodiments of this application. The t frames may be any t frames before the (k−1)^{th} frame, or may be t frames that are before the (k−1)^{th} frame and that are closest to the (k−1)^{th} frame. This is not limited in embodiments of this application.

It should be noted that the first volume threshold is preset, and the first volume threshold indicates whether an environment is currently quiet. In other words, if the target environmental volume is less than or equal to the first volume threshold, it indicates that the environment is quiet. If the target environmental volume is greater than the first volume threshold, it indicates that the environment is not quiet. The first noise cancellation amplitude is preset for a quiet environment, and is used to perform weak noise cancellation, so as to avoid excessively amplifying background noise or introducing a subjective comfort problem. In actual application, the first volume threshold and the first noise cancellation amplitude may be adjusted based on different requirements.

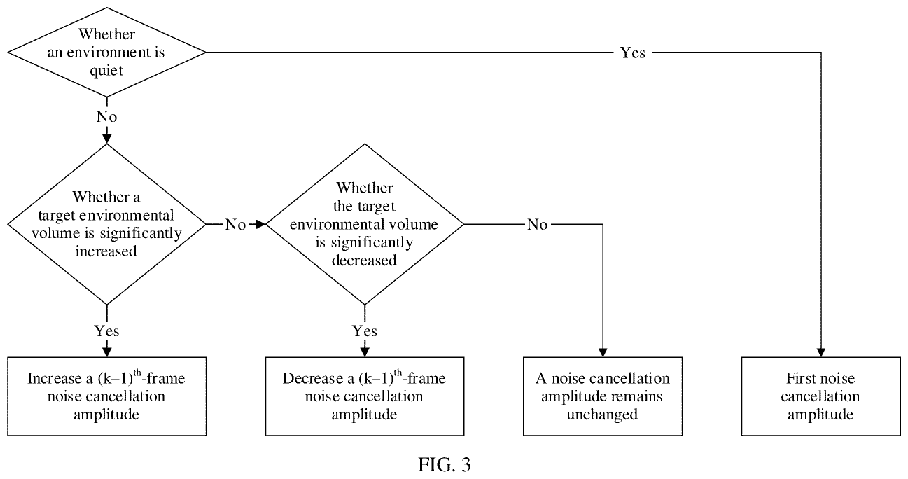

For example, refer to FIG. 3. Whether the environment is quiet is determined based on the target environmental volume, and when the environment is quiet, the first noise cancellation amplitude is determined as the target noise cancellation amplitude. In the non-quiet environment, if the target environmental volume significantly increases, the (k−1)^{th}-frame noise cancellation amplitude is increased, to obtain the target noise cancellation amplitude. If the target environmental volume is significantly decreased, the (k−1)^{th}-frame noise cancellation amplitude is decreased, to obtain the target noise cancellation amplitude. If the target environmental volume is not significantly increased and is not significantly decreased, the (k−1)^{th}-frame noise cancellation amplitude is determined as the target noise cancellation amplitude, that is, the noise cancellation amplitude remains unchanged.

There are a plurality of manners of determining whether the target environmental volume is significantly increased or significantly decreased. For example, if a target environmental volume determined this time is greater than a target environmental volume determined last time, and a difference between the target environmental volume determined this time and the target environmental volume determined last time is greater than a second volume threshold, it is determined that the target environmental volume determined this time is significantly increased. Similarly, if the target environmental volume determined this time is less than the target environmental volume determined last time, and the difference between the target environmental volume determined this time and the target environmental volume determined last time is greater than the second volume threshold, it is determined that the target environmental volume determined this time is significantly decreased.

The second volume threshold is also preset, for example, 3 dB. In actual application, the second volume threshold may be further adjusted based on different requirements.

In a second case, the headset further includes the one FB filter, but does not include the at least one second FF filter. In this case, the k^{th}-frame filter coefficient of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and a (k−1)^{th}-frame filter coefficient of the FB filter.

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and the (k−1)^{th}-frame filter coefficient of the FB filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{h}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, and the (k−1)^{th}-frame filter coefficient of the FB filter.

In an example, frequency response information of the (k−1)^{th}-frame filter coefficient of the target SP and frequency response information of the (k−1)^{th}-frame filter coefficient of the FB filter may be determined. Then, the k^{th}-frame frequency response information of the first FF filter is determined according to the following formula (3) based on the (k−1)^{th}-frame frequency response information of the first FF filter, the frequency response information of the (k−1)^{th}-frame filter coefficient of the target SP, the residual error, and the frequency response information of the (k−1)^{th}-frame filter coefficient of the FB filter.

$$F {F}_{k} = F {F}_{k - 1} + μ \frac{{Res}_{k - 1}}{S {P}_{k - 1}} * ( 1 + {FB}_{k - 1} * {SP}_{k - 1} ) \qquad ( 3 )$$

In the foregoing formula (3), FBₖ₋₁, indicates the frequency response information of the (k−1)^{th}-frame filter coefficient of the FB filter. Meanings represented by other letters are the same as those in the foregoing formula (2). Details are not described herein again.

An implementation process of determining the residual error and an implementation process of determining the k^{th}-frame filter coefficient of the first FF filter based on the k^{th}-frame frequency response information of the first FF filter are the same as those in the first case. For detailed implementation processes, refer to the foregoing descriptions. Details are not described herein again.

In a third case, the headset does not include the FB filter, but includes the at least one second FF filter. In this case, the k^{th}-frame filter coefficient of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and (k−1)^{th}-frame frequency response information of the at least one second FF filter.

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, and the (k−1)^{th}-frame frequency response information of the at least one second FF filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, and the (k−1)^{th}-frame frequency response information of the at least one second FF filter.

In an example, frequency response information of the (k−1)^{th}-frame filter coefficient of the target SP may be determined. Then, the k^{th}-frame frequency response information of the first FF filter is determined according to the following formula (4) based on the (k−1)^{th}-frame frequency response information of the first FF filter, the frequency response information of the (k−1)^{th}-frame filter coefficient of the target SP, the residual error, and the (k−1)^{th}-frame frequency response information of the at least one second FF filter.

$$F {F}_{k} = F {F}_{k - 1} + μ \frac{{Res}_{k - 1} + {\sum }_{j = 1}^{h} F {F}_{j , k - 1} * {SP}_{k - 1}}{S {P}_{k - 1}} \qquad ( 4 )$$

In the foregoing formula (4), FF_{j,k-1} indicates (k−1)^{th}-frame frequency response information of a j^{th} FF filter in the at least one second FF filter, h indicates a total quantity of the at least one second FF filter. Meanings represented by other letters are the same as those in the foregoing formula (2). Details are not described herein again.

An implementation process of determining the residual error and an implementation process of determining the k^{th}-frame filter coefficient of the first FF filter based on the k^{th}-frame frequency response information of the first FF filter are the same as those in the first case. For detailed implementation processes, refer to the foregoing descriptions. Details are not described herein again. In addition, the (k−1)^{th}-frame frequency response information of the at least one second FF filter may be determined according to a related algorithm based on a respective (k−1)^{th}-frame filter coefficient. The algorithm is not limited in embodiments of this application.

In a fourth case, the headset includes the FB filter and the at least one second FF filter. In this case, the k^{th}-frame filter coefficient of the first FF filter is determined based on the (k−1)^{th}-frame reference signal collected by the at least one first reference microphone, the (k−1)^{h}-frame error signal collected by the error microphone, the (k−1)^{th}-frame filter coefficient of the target SP, a (k−1)^{th}-frame filter coefficient of the FB filter, and (k−1)^{th}-frame frequency response information of the at least one second FF filter.

Herein, k^{th}-frame frequency response information of the first FF filter is determined based on the (k−1)^{th}-frame reference signal collected by the at least one first reference microphone, the (k−1)^{th}-frame error signal collected by the error microphone, the (k−1)^{th}-frame filter coefficient of the target SP, the (k−1)^{th}-frame filter coefficient of the FB filter, and the (k−1)^{th}-frame frequency response information of the at least one second FF filter. The k^{th}-frame filter coefficient of the first FF filter is determined based on the k^{th}-frame frequency response information of the first FF filter.

When the k^{th}-frame frequency response information of the first FF filter is determined, a residual error may be determined based on the (k−1)^{th}-frame reference signal collected by the at least one first reference microphone and the (k−1)^{th}-frame error signal collected by the error microphone, and the k^{th}-frame frequency response information of the first FF filter is determined based on (k−1)^{th}-frame frequency response information of the first FF filter, the (k−1)^{th}-frame filter coefficient of the target SP, the residual error, the (k−1)^{h}-frame filter coefficient of the FB filter, and the (k−1)^{th}-frame frequency response information of the at least one second FF filter.

In an example, frequency response information of the (k−1)^{th}-frame filter coefficient of the target SP and frequency response information of the (k−1)^{th}-frame filter coefficient of the FB filter may be determined. Then, the k^{th}-frame frequency response information of the first FF filter is determined according to the following formula (5) based on the (k−1)^{th}-frame frequency response information of the first FF filter, the frequency response information of the (k−1)^{th}-frame filter coefficient of the target SP, the residual error, the frequency response information of the (k−1)^{th}-frame filter coefficient of the FB filter, and the (k−1)^{th}-frame frequency response information of the at least one second FF filter.

$$F {F}_{k} = F {F}_{k - 1} + μ \frac{{Res}_{k - 1} * ( 1 + {FB}_{k - 1} * {SP}_{k - 1} ) + {\sum }_{j = 1}^{h} F {F}_{j , k - 1} * {SP}_{k - 1}}{S {P}_{k - 1}} \qquad ( 5 )$$

In the foregoing formula (5), FBₖ₋₁ indicates the frequency response information of the (k−1)^{th}-frame filter coefficient of the FB filter. Meanings represented by other letters are the same as those in the foregoing formulas. Details are not described herein again.

An implementation process of determining the residual error and an implementation process of determining the k^{th}-frame filter coefficient of the first FF filter based on the k^{th}-frame frequency response information of the first FF filter are the same as those in the first case. For detailed implementation processes, refer to the foregoing descriptions. Details are not described herein again. In addition, frequency response information of filter coefficients of the SPs may be determined according to a related algorithm based on the filter coefficients of the SP, and frequency response information of FB filter coefficients may also be determined according to a related algorithm based on filter coefficients of the FB filters. The algorithm is not limited in embodiments of this application.

In the foregoing processes of determining the k^{th}-frame frequency response information of the first FF filter, regardless of whether the headset includes an FB filter, the k^{th}-frame frequency response information of the first FF filter is determined based on the (k−1)^{th}-frame filter coefficient of the target SP, and the (k−1)^{th}-frame filter coefficient of the target SP is determined based on the target noise canceling level by querying the mapping relationship between the noise canceling level and the filter coefficient of the SP. To be specific, the (k−1)^{th}-frame filter coefficient of the target SP is an estimated value, and the k^{th}-frame frequency response information of the first FF filter is determined based on the estimated value, so that dependence on a real value of the target SP can be eliminated, and adaptation of a filter coefficient of an FF filter can also be implemented even when there is no downlink signal.

(2) Determine the k^{th}-Frame Filter Coefficient of the FB Filter.

When k is equal to 1, an initial filter coefficient of the FB filter is determined as the k^{th}-frame filter coefficient of the FB filter, that is, a first-frame filter coefficient of the FB filter is the initial filter coefficient of the FB filter, or the k^{th}-frame filter coefficient of the FB filter is determined based on an initial noise canceling level and a mapping relationship between a noise canceling level and an FB filter coefficient. When k is greater than 1, the k^{th}-frame filter coefficient of the FB filter may be determined based on the target noise canceling level. The initial noise cancellation coefficient includes the initial filter coefficient of the FB filter, and the initial filter coefficient may or may not be 0. This is not limited in embodiments of this application.

When k is greater than 1, the k^{th}-frame filter coefficient of the FB filter may be determined in the following two manners.

In a first manner, the k^{th}-frame filter coefficient of the FB filter is determined based on the target noise canceling level and the mapping relationship between the noise canceling level and the FB filter coefficient.

The mapping relationship between the noise canceling level and the FB filter coefficient includes a plurality of noise canceling levels, a mapping relationship exists between each noise canceling level and a filter coefficient of the FB filter, and mapping relationships between different noise canceling levels and the filter coefficient of the FB filter may be different. Therefore, a filter coefficient corresponding to the FB filter can be obtained from the mapping relationship between the noise canceling level and the FB filter coefficient based on the target noise canceling level, and the obtained filter coefficient is used as the k^{th}-frame filter coefficient of the FB filter.

Because the mapping relationship between the noise canceling level and the FB filter coefficient is stored in advance, determining the k^{th}-frame filter coefficient of the FB filter in the first manner is stable, an operation is simple, and efficiency is high.

In a second manner, the k^{th}-frame filter coefficient of the FB filter is determined based on the (k−1)^{th}-frame error signal collected by the error microphone, a (k−1)^{th}-frame filter coefficient of the FB filter, and the target noise canceling level.

Similar to the foregoing descriptions, when k is greater than 1, the k^{th}-frame filter coefficient of the FB filter may be determined according to an adaptation method. The process of determining the k^{th}-frame filter coefficient of the FB filter is an adaptation process, and may also be referred to as an iteration process.

An implementation process of determining the k^{th}-frame filter coefficient of the FB filter based on the (k−1)^{th}-frame error signal collected by the error microphone, the (k−1)^{th}-frame filter coefficient of the FB filter, and the target noise canceling level includes: determining a (k−1)^{th}-frame filter coefficient of a target SP based on the target noise canceling level and a mapping relationship between a noise canceling level and a filter coefficient of an SP, where the target SP is a path from the target speaker to the error microphone; and determining the k^{th}-frame filter coefficient of the FB filter based on the (k−1)^{th}-frame error signal collected by the error microphone, the (k−1)^{th}-frame filter coefficient of the FB filter, and the (k−1)^{th}-frame filter coefficient of the target SP.

The k^{th}-frame filter coefficient of the FB filter may be determined according to a related algorithm based on the (k−1)^{th}-frame error signal collected by the error microphone, the (k−1)^{th}-frame filter coefficient of the FB filter, and the (k−1)^{th}-frame filter coefficient of the target SP. The algorithm is not limited in embodiments of this application.

The first-frame filter coefficient of the FB filter may be determined based on the initial noise canceling level by querying the mapping relationship between the noise canceling level and the FB filter coefficient. Therefore, when k is greater than or equal to 1, it is equivalent to that the k^{th}-frame filter coefficient of the FB filter may be determined in two manners: (1) The k^{th}-frame filter coefficient of the FB filter is determined by querying the mapping relationship between the noise canceling level and the FB filter coefficient. (2) If k is equal to 1, the k^{th}-frame filter coefficient of the FB filter is determined by querying the mapping relationship between the noise canceling level and the FB filter coefficient. If k is greater than 1, the k^{th}-frame filter coefficient of the FB filter is determined based on the (k−1)^{th}-frame error signal collected by the error microphone, the (k−1)^{th}-frame filter coefficient of the FB filter, and the target noise canceling level.

In the foregoing second manner, a manner of querying the mapping relationship between the noise canceling level and the FB filter coefficient is combined with an adaptive manner, so that noise cancellation effect can be improved, complexity is not high, and stability is controllable.

It should be noted that, in embodiments of this application, the k^{th}-frame filter coefficient of the FB filter may be determined in the foregoing two manners, and the k^{th}-frame filter coefficient of the FB filter may alternatively be determined in another manner. For example, regardless of whether k is greater than 1 or equal to 1, the k^{th}-frame filter coefficient of the FB filter is determined based on the (k−1)^{th}-frame error signal collected by the error microphone, the (k−1)^{th}-frame filter coefficient of the FB filter, and the target noise canceling level. This is not limited in embodiments of this application.

(3) Determine the k^{th}-Frame Filter Coefficient of the Downlink Compensation Filter.

When k is equal to 1, an initial filter coefficient of the downlink compensation filter is determined as the k^{th}-frame filter coefficient of the downlink compensation filter, or the k^{th}-frame filter coefficient of the downlink compensation filter is determined based on an initial noise canceling level and a mapping relationship between a noise canceling level and a downlink compensation filter coefficient. When k is greater than 1, the k^{th}-frame filter coefficient of the downlink compensation filter is determined based on the target noise canceling level and the mapping relationship between the noise canceling level and the downlink compensation filter coefficient.

The mapping relationship between the noise canceling level and the downlink compensation filter coefficient includes a plurality of noise canceling levels, a mapping relationship exists between each noise canceling level and a filter coefficient of the downlink compensation filter, and mapping relationships between different noise canceling levels and filter coefficients of the downlink compensation filter may be different. Therefore, after the target noise canceling level is determined, a corresponding downlink compensation filter coefficient can be obtained from the mapping relationship between the noise canceling level and the downlink compensation filter coefficient based on the target noise canceling level, and the obtained downlink compensation filter coefficient is used as the k^{th}-frame filter coefficient of the downlink compensation filter.

### (4) Determine the Target Noise Canceling Level.

A (k−1)^{th}-frame noise canceling level is determined, and noise canceling levels in m frames before a (k−1)^{th} frame are obtained, where m is greater than or equal to 1 and less than k−1. The target noise canceling level is determined based on the (k−1)^{th}-frame noise canceling level and the noise canceling levels in the m frames.

In the (k−1)^{th} frame, a valid downlink signal may exist, or no valid downlink signal may exist, and an environment may be quiet, or an environment may not be quiet, or certainly, an abnormal signal may exist. In different cases, manners of determining the (k−1)^{th}-frame noise canceling level are different, and are separately described below.

In a first case, in the (k−1)^{th} frame, no valid downlink signal exists and the environment is not quiet. In this case, the (k−1)^{th}-frame noise canceling level is determined based on a reference filter coefficient of the first FF filter and a mapping relationship between a noise canceling level and frequency response information of the first FF filter. When k is equal to 2, the reference filter coefficient is an initial filter coefficient of the first FF filter; or when k is greater than 2, the reference filter coefficient is a filter coefficient that is of the first FF filters and that meets a convergence stability condition last time before a k^{th} frame, or is a (k−1)^{th}-frame filter coefficient of the first FF filter.

When an audio signal is played through the headset, for example, music is played or a call is made, a user terminal delivers control signaling for playing the audio signal to the headset. Therefore, whether the headset is currently in a downlink enabled state may be determined based on whether the headset receives the control signaling. When the headset is not in the downlink enabled state, it is determined that no valid downlink signal exists in the (k−1)^{th} frame. When the headset is in the downlink enabled state, there may not necessarily be a sound continuously output in the (k−1)^{th} frame. For example, no sound is output in a pause period of a speech, a transition period of music change, and the like, and the time is usually not short. Therefore, when the headset is in the downlink enabled state, it may be further determined whether the (k−1)^{th} frame is in a downlink intermittent period. If the (k−1)^{th} frame is in the downlink intermittent period, it is determined that no valid downlink signal exists in the (k−1)^{th} frame. If the (k−1)^{th} frame is not in a downlink intermittent period, it is determined that the valid downlink signal exists in the (k−1)^{th} frame.

When no valid downlink signal exists in the (k−1)^{th} frame but the environment is not quiet, the (k−1)^{th}-frame noise canceling level may vary with different environmental noise. Therefore, the (k−1)^{th}-frame noise canceling level needs to be determined based on the reference filter coefficient of the first FF filter and the mapping relationship between the noise canceling level and the frequency response information of the first FF filter.

In some embodiments, reference frequency response information of the first FF filter is determined based on the reference filter coefficient of the first FF filter. A noise canceling level matching the reference frequency response information of the first FF filter is determined based on the mapping relationship between the noise canceling level and the frequency response information of the first FF filter, to obtain the (k−1)^{th}-frame noise canceling level.

The reference frequency response information of the first FF filter may be determined according to a related algorithm based on the reference filter coefficient of the first FF filter. The algorithm is not limited in embodiments of this application.

When noise canceling levels are different, frequency response information of an FF filter may also be different. Therefore, the mapping relationship between the noise canceling level and the frequency response information of the first FF filter may be stored in advance. In this way, after the reference frequency response information of the first FF filter is determined, matching is performed between the reference frequency response information of the first FF filter and frequency response information of the FF filter at different noise canceling levels in the mapping relationship, to determine, from the mapping relationship, frequency response information matching the reference frequency response information of the first FF filter, and then use a noise canceling level corresponding to the matched frequency response information as the (k−1)^{th}-frame noise canceling level.

The frequency response information of the FF filter may be represented by using a frequency response curve. Therefore, after a reference frequency response curve of the first FF filter is determined, matching may be performed between the reference frequency response curve of the first FF filter and frequency response curves of the FF filter at the different noise canceling levels in the mapping relationship.

In actual application, matching may be performed between the complete reference frequency response curve of the first FF filter and the complete frequency response curves of the FF filter at the different noise canceling levels in the mapping relationship. Alternatively, matching may be performed between a curve that is in the reference frequency response curve of the first FF filter and that is in a target frequency band and curves that are in the frequency response curves of the FF filter at the different noise canceling levels in the mapping relationship and that are in the target frequency band. This is not limited in embodiments of this application.

It should be noted that the target frequency band is a frequency band with obvious distinguishing features in the frequency response curves, and the target frequency band is preset. For example, the target frequency band is a frequency band from 100 hertz to 200 hertz (Hz). Certainly, in different acoustic conditions of the headset, values of the target frequency band may also be different.

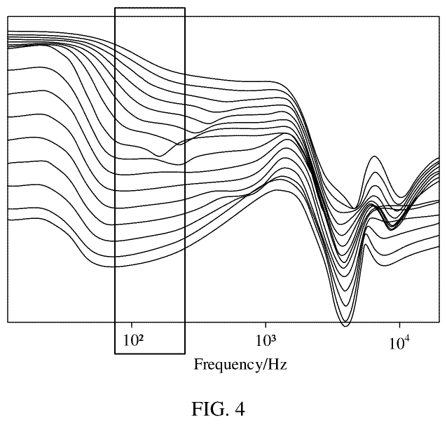

For example, the mapping relationship between the noise canceling level and the frequency response information of the first FF filter includes frequency response curves of the FF filter at 16 noise canceling levels, and the frequency response curves of the FF filter at the 16 noise canceling levels are shown in FIG. 4. Because features in the frequency band from 100 Hz to 200 Hz in FIG. 4 are obviously distinguished, the frequency band from 100 Hz to 200 Hz is used as the target frequency band. Then, matching is performed between a curve that is in the reference frequency response curve of the first FF filter and that falls within a range from 100 Hz to 200 Hz and curves that are in the frequency response curves of the FF filter at the 16 noise canceling levels and that fall within the range from 100 Hz to 200 Hz.

Because a process of determining a filter coefficient of the first FF filter is an iteration process, and may also be referred to as an adaptation process, the foregoing convergence stability condition indicates that the filter coefficient of the first FF filter converges to basically remain unchanged. In addition, because the filter coefficient of the first FF filter may be adaptively adjusted a plurality of times in the entire noise cancellation process, when a k^{th}-frame filter coefficient of the first FF filter is determined, a filter coefficient that is of the first FF filter and that meets the convergence stability condition last time before the k^{th} frame may be used as a reference filter coefficient, or the (k−1)^{th}-frame filter coefficient of the first FF filter may be used as a reference filter coefficient.

In a second case, the valid downlink signal exists in the (k−1)^{th} frame. In this case, the (k−1)^{th}-frame noise canceling level is determined based on the (k−1)^{th}-frame valid downlink signal, a (k−1)^{th}-frame reference signal collected by the at least one first reference microphone, and a (k−1)^{th}-frame error signal collected by the error microphone.

In view of the foregoing descriptions, when the headset is in a downlink enabled state and is not in a downlink intermittent period, it is determined that the valid downlink signal exists in the (k−1)^{th} frame. In this case, a valid downlink signal may be extracted from the (k−1)^{th}-frame error signal collected by the error microphone based on the (k−1)^{th}-frame valid downlink signal, the (k−1)^{th}-frame reference signal collected by the at least one first reference microphone, and the (k−1)^{th}-frame error signal collected by the error microphone, to determine the (k−1)^{th}-frame noise canceling level based on the extracted valid downlink signal.

The valid downlink signal may be extracted from the (k−1)^{th}-frame error signal collected by the error microphone according to a related algorithm based on the (k−1)^{th}-frame valid downlink signal, the (k−1)^{th}-frame reference signal collected by the at least one first reference microphone, and the (k−1)^{th}-frame error signal collected by the error microphone, to determine the (k−1)^{th}-frame noise canceling level based on the extracted valid downlink signal. The algorithm is not limited in embodiments of this application.

In a third case, in the (k−1)^{th} frame, no valid downlink signal exists and the environment is quiet, or the abnormal noise signal exists in the (k−1)^{th} frame. In this case, a (k−3)^{th}-frame noise canceling level is determined as the (k−1)^{th}-frame noise canceling level. In other words, the noise canceling level remains unchanged.

In the (k−1)^{th} frame, when no valid downlink signal exists and the environment is quiet, noise basically does not change. In this case, the noise canceling level may remain unchanged. When the abnormal noise signal exists in the (k−1)^{th} frame, the noise canceling level remains unchanged, to perform robustness control, and avoid divergence of the noise canceling level.

The abnormal noise signal indicates a signal that has a severe impact on user listening experience, for example, howling, clipping, background noise, and wind noise. Howling is a phenomenon in which an amplitude or energy of a single-frequency sound signal suddenly increases from a small value, and is usually caused by an action like squeezing a headset, or quickly changing a wearing posture of a headset by a user. A sound signal emitted during howling is referred to as howling noise. Howling causes user discomfort, interferes with playing of a downlink signal, and seriously affects audio playing effect. Clipping is a phenomenon in which a low-band signal overflows and generates crack noise, and the generated crack noise is referred to as clipping noise. Generally, clipping occurs when low-band large noise bursts in an environment. For example, low-band large noise is generated when a vehicle is bumped or an airplane is landed. The background noise is ground noise, and the background noise may also be referred to as noise floor. The background noise is noise caused by performance limitation of hardware (for example, a circuit or another component in a headset) of a device, for example, a rustling sound other than a program sound in a television sound. In a noisy environment, background noise cannot be perceived or heard by a user. When the environment is quiet, the user can perceive the background noise. Too strong background noise not only annoys people, but also submerges weak details in a sound. The wind noise is generated when there is wind in an environment. The wind noise affects normal use of a headset by a user. In addition, because a direction of the wind noise is randomized, impact of the wind noise on ears of the user is different. In other words, the left ear and the right ear have different hearing feelings under the impact of the wind noise.

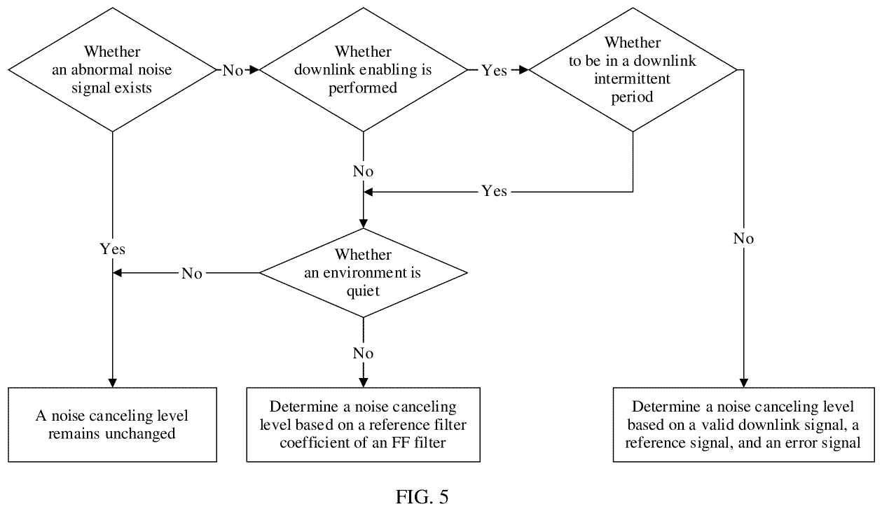

The following briefly summarizes the foregoing three cases with reference to FIG. 5. Refer to FIG. 5, when the abnormal noise signal exists in the (k−1)^{th} frame, the noise canceling level remains unchanged. When no abnormal noise signal exists in the (k−1)^{th} frame, it is determined whether downlink enabling is performed in the (k−1)^{th} frame. When downlink enabling is not performed in the (k−1)^{th} frame, it is determined whether the environment is quiet in the (k−1)^{th} frame. When the environment is quiet in the (k−1)^{th} frame, the noise canceling level remains unchanged. When the environment is not quiet in the (k−1)^{th} frame, the (k−1)^{th}-frame noise canceling level is determined based on a reference filter coefficient of the FF filter. When downlink enabling is performed in the (k−1)^{th} frame, it is determined whether the (k−1)^{th} frame is in a downlink intermittent period. When the (k−1)^{th} frame is in the downlink intermittent period, the (k−1)^{th}-frame noise canceling level is determined in the same manner. When the (k−1)^{th} frame is not in the downlink intermittent period, the (k−1)^{th}-frame noise canceling level is determined based on a (k−1)^{th}-frame valid downlink signal, the (k−1)^{th}-frame reference signal collected by the at least one first reference microphone, and the (k−1)^{th}-frame error signal collected by the error microphone.

After the (k−1)^{th}-frame noise canceling level is determined in the foregoing three cases, the (k−1)^{th}-frame noise canceling level and the noise canceling levels in the m frames before the (k−1)^{th} frame may be integrated, to determine the target noise canceling level.

The noise canceling levels in the m frames may be noise canceling levels in any m frames before the (k−1)^{th} frame, or may be noise canceling levels in m frames that are before the (k−1)^{th} frame and that are closest to the (k−1)^{th} frame. This is not limited in embodiments of this application. In addition, there are a plurality of implementations of determining the target noise canceling level based on the (k−1)^{th}-frame noise canceling level and the noise canceling levels in the m frames before the (k−1)^{th} frame. For example, noise cancellation effect is evaluated according to a related algorithm, to determine a noise cancellation probability corresponding to the (k−1)^{th}-frame noise canceling level and noise cancellation probabilities corresponding to the noise canceling levels in the m frames, and determine a noise canceling level with a largest noise cancellation probability as the target noise canceling level. Alternatively, an arithmetic average value or a weighted average value of the (k−1)^{th}-frame noise canceling level and the noise canceling levels in the m frames is determined, to obtain the target noise canceling level. Alternatively, a noise canceling level that appears most frequently in the (k−1)^{th}-frame noise canceling level and the noise canceling levels in the m frames is determined as the target noise canceling level, or the like.

The foregoing various mapping relationships are determined in advance. For example, when one of the at least one speaker works and the other speakers do not work, the various mapping relationships are determined based on a reference signal collected by the at least one first reference microphone and an error signal collected by the error microphone in each of a plurality of leakage states. The plurality of leakage states are formed by the headset and a plurality of different ear canal environments, and the plurality of leakage states are in a one-to-one correspondence with a plurality of noise canceling levels.

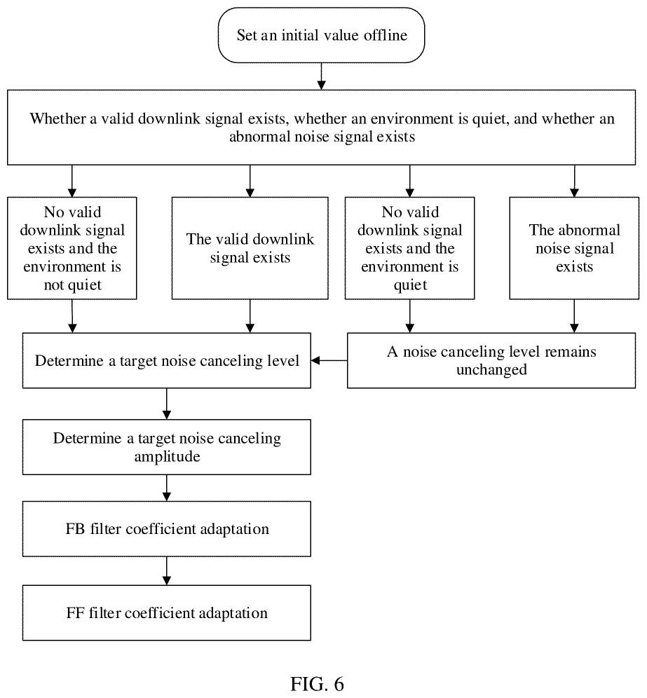

In this case, the target noise cancellation parameter has been determined. A process of determining the target noise cancellation parameter is briefly summarized below by using FIG. 6 as an example. Refer to FIG. 6. An initial value, including the foregoing initial noise canceling level, initial filter coefficient, and various mapping relationships, may be set offline. Then, in the (k−1)^{th} frame, it is determined whether the valid downlink signal exists, whether the environment is quiet, and whether the abnormal noise signal exists, to determine the (k−1)^{th}-frame noise canceling level based on different cases. The target noise canceling level is determined based on the (k−1)^{th}-frame noise canceling level and the previous noise canceling levels in the m frames. Then, a target noise cancellation amplitude is determined based on a (k−1)^{th}-frame environmental volume, and FB filter coefficient adaptation is performed based on the target noise canceling level, to determine the k^{th}-frame filter coefficient of the FB filter. Finally, FF filter coefficient adaptation is performed based on the target noise canceling level and the target noise cancellation amplitude, to determine the k^{th}-frame filter coefficient of the first FF filter.

Step 202: Perform noise cancellation through a target speaker in the at least one speaker based on the target noise cancellation parameter.

Target inverse phase noise is generated based on the target noise cancellation parameter, and noise cancellation is performed through the target speaker in the at least one speaker based on the target inverse phase noise.

When the target noise cancellation parameter includes the k^{th}-frame filter coefficient of the first FF filter, the target inverse phase noise includes feedforward inverse phase noise. In this case, a k^{th}-frame reference signal collected by the at least one first reference microphone may be processed based on the k^{th}-frame filter coefficient of the first FF filter, to obtain the feedforward inverse phase noise.

In view of the foregoing descriptions, the at least one first reference microphone may include one reference microphone, or may include at least two reference microphones. When the at least one first reference microphone includes one reference microphone, the k^{th}-frame reference signal collected by the reference microphone may be processed directly based on the k^{th}-frame filter coefficient of the first FF filter, to obtain the feedforward inverse phase noise. When the at least one first reference microphone includes at least two reference microphones, audio mixing is performed on k^{th}-frame reference signals collected by the at least two reference microphones, to obtain a k^{th}-frame mixed reference signal, and then the k^{th}-frame mixed reference signal is processed based on the k^{th}-frame filter coefficient of the first FF filter, to obtain the feedforward inverse phase noise.

Optionally, the headset may further include at least one second FF filter. In this case, a k^{th}-frame filter coefficient of the at least one second FF filter may be determined. Noise cancellation is performed through the target speaker based on the target noise cancellation parameter and the k^{th}-frame filter coefficient of the at least one second FF filter. In other words, the k^{th}-frame reference signal collected by the at least one first reference microphone is processed based on the k^{th}-frame filter coefficient of the first FF filter, to obtain first feedforward inverse phase noise. The k^{th}-frame reference signal collected by the at least one first reference microphone is processed based on the k^{th}-frame filter coefficient of the at least one second FF filter, to obtain at least one second feedforward inverse phase noise.

When k is equal to 1, an initial filter coefficient of the at least one second FF filter is determined as the k^{th}-frame filter coefficient of the at least one second FF filter, that is, a first-frame filter coefficient of the at least one second FF filter is the initial filter coefficient of the corresponding second FF filter, or the k^{th}-frame filter coefficient of the at least one second FF filter is determined based on an initial noise canceling level and a mapping relationship between a noise canceling level and a second FF filter coefficient. When k is greater than 1, the k^{th}-frame filter coefficient of the at least one second FF filter is determined based on the target noise canceling level and the mapping relationship between the noise canceling level and the second FF filter coefficient. The initial noise cancellation coefficient includes the initial filter coefficient of the at least one second FF filter, and the initial filter coefficient may be equal to 0 or may not be 0. This is not limited in embodiments of this application.

The mapping relationship between the noise canceling level and the second FF filter coefficient includes a plurality of noise canceling levels, a mapping relationship exists between each noise canceling level and a filter coefficient of the at least one second FF filter, and mapping relationships between different noise canceling levels and the filter coefficient of the at least one second FF filter may be different. Therefore, after the target noise canceling level is determined, a filter coefficient corresponding to the at least one second FF filter can be obtained from the mapping relationship between the noise canceling level and the second FF filter coefficient based on the target noise canceling level, and the obtained filter coefficient is used as the k^{th}-frame filter coefficient of the at least one second FF filter. The same applies to the initial noise canceling level.

The foregoing descriptions are provided by using an example in which both the first FF filter and the at least one second FF filter correspond to the at least one first reference microphone. In actual application, the first FF filter and the at least one second FF filter may alternatively correspond to different reference microphones. For example, the headset further includes a plurality of second reference microphones, the first FF filter corresponds to at least one first reference microphone, and each second FF filter corresponds to at least one second reference microphone in the plurality of second reference microphones. In this case, the k^{th}-frame reference signal collected by the at least one first reference microphone may be processed based on the k^{th}-frame filter coefficient of the first FF filter, to obtain the first feedforward inverse phase noise. A k^{th}-frame reference signal collected by the at least one second reference microphone corresponding to each second FF filter is processed based on a k^{th}-frame filter coefficient of each second FF filter, to obtain the at least one second feedforward inverse phase noise.

When the headset further includes an FB filter, the target inverse phase noise further includes feedback inverse phase noise. In other words, downlink compensation is performed on a k^{th}-frame downlink signal sent by a user terminal. In other words, downlink compensation is performed, based on the k^{th}-frame filter coefficient of the downlink compensation filter, on the k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The k^{th}-frame noise signal collected by the error microphone is processed based on the k^{th}-frame filter coefficient of the FB filter, to obtain the feedback inverse phase noise.

Downlink compensation can be used to remove all downlink signals in error signals collected by the error microphone, so that noise cancellation is performed only on a residual noise signal through the FB filter, to avoid a sound quality damage to the downlink signals. In addition, downlink compensation is performed on the k^{th}-frame downlink signal sent by the user terminal, so that downlink signals of all speakers at the error microphone can be removed, to avoid a sound quality damage to full-band downlink signals.

In view of the foregoing descriptions, when the target noise cancellation parameter is determined on a per-frame basis, because one frame may include one sample point, or may include a plurality of sample points, when the target inverse phase noise is generated, a group of target inverse phase noise may be generated at each sample point, or a group of target inverse phase noise may be generated in one frame.

In embodiments of this application, when the target noise cancellation parameter is determined, frequency division is not performed on the downlink signals, that is, the target noise cancellation parameter is determined based on full-band downlink signals. In this way, after the target inverse phase noise is generated based on the target noise cancellation parameter, a frequency band of the target inverse phase noise covers a sound-making frequency band of the at least one speaker, that is, the frequency band of the target inverse phase noise is a full frequency band.

After the target inverse phase noise is generated, the target inverse phase noise is mixed with a k^{th}-frame downlink signal to be played through the target speaker, and then a mixed signal is played through the target speaker, to achieve noise cancellation.

The at least one speaker may include one speaker, or may include a plurality of speakers. When the at least one speaker includes one speaker, the speaker may be a full-band speaker. When the at least one speaker includes a plurality of speakers, some of the plurality of speakers may be high-band speakers, and the other may be low-band speakers. Alternatively, some of the plurality of first speakers are full-band speakers, and the other are non-full-band speakers. In other words, sound-making frequency bands of the plurality of speakers may be different. Alternatively, the plurality of speakers are all full-band speakers. Alternatively, the plurality of speakers are all non-full-band speakers. When the plurality of speakers are all the full-band speakers, k^{th}-frame downlink signals to be played through the plurality of speakers are all the k^{th}-frame downlink signal sent by the user terminal. When not all of the plurality of speakers are full-band speakers, frequency division needs to be performed, based on a sound-making frequency band of each speaker, on the k^{th}-frame downlink signal sent by the user terminal, to obtain a k^{th}-frame downlink signal to be played through each speaker.

In embodiments of this application, noise cancellation is performed through the target speaker in the at least one speaker. When the at least one speaker includes one speaker, the speaker is the target speaker. When the at least one speaker includes a plurality of speakers, and the plurality of speakers include a first speaker and a second speaker on which digital frequency division is performed, the target speaker is the first speaker, and the second speaker does not participate in noise cancellation. However, the second speaker may participate in downlink compensation (that is, downlink compensation is performed on a downlink signal sent by the user terminal, where the downlink signal is a full-band audio signal, including an audio signal at a sound-making frequency band of the second speaker). In this case, the first speaker may be a low- and medium-band speaker, or may be a full-band speaker, and the second speaker may be a high-band speaker, or may be a medium-band speaker or a low-band speaker. Optionally, the second speaker may not participate in downlink compensation. In this case, the first speaker may be the low- and medium-band speaker, or may be the full-band speaker, and the second speaker is the high-band speaker.

Optionally, the at least one speaker may alternatively include a first speaker and a second speaker on which analog frequency division is performed. In this case, the target speaker is the first speaker and the second speaker, that is, both the first speaker and the second speaker participate in noise cancellation.

When the target speaker is the first speaker and the second speaker, the first speaker and the second speaker may be an analog frequency division combination of the two speakers. In other words, the first speaker and the second speaker are driven by using a same DAC and PA, and the combination of the first speaker and the second speaker may be considered as one speaker.

It should be noted that the sound-making frequency band of the at least one second speaker is higher than a sound-making frequency band of the at least one first speaker. Certainly, the sound-making frequency band of the at least one second speaker may alternatively be lower than the sound-making frequency band of the at least one first speaker. This is not limited in embodiments of this application.

In addition, the foregoing process of determining the target noise cancellation parameter according to the adaptation method requires specific time, and when one frame includes a plurality of sample points and duration of the one frame is long, duration of determining the target noise cancellation parameter is less than the duration of the one frame. Therefore, calculation may be performed in a part of a time period of the k^{th} frame based on related data of the (k−1)^{th} frame, to obtain a k^{th}-frame target noise cancellation parameter, and perform active noise cancellation in the other part of the time period of the k^{th} frame based on the k^{th}-frame target noise cancellation parameter. However, when the one frame includes one sample point, or the one frame includes a plurality of sample points and the duration of the one frame is short, the duration of determining the target noise cancellation parameter may be equal to the duration of the one frame. In this case, calculation may need to be performed in the entire time period of the k^{th} frame based on the related data of the (k−1)^{th} frame, to obtain the target noise cancellation parameter. In this case, the target noise cancellation parameter may be determined as a (k+1)^{th}-frame target noise cancellation parameter, and then active noise cancellation is performed in a time period of a (k+1)^{th} frame based on the (k+1)^{th}-frame target noise cancellation parameter. The foregoing content is described by using the later case as an example.

In conclusion, in embodiments of this application, the target noise cancellation parameter is determined based on the reference signal collected by the at least one first reference microphone, the error signal collected by the error microphone, and the initial noise cancellation coefficient. This eliminates dependence on a downlink signal, so that the target noise cancellation parameter can be determined even when there is no downlink signal, to perform adaptive noise cancellation.

The following describes several possible headset architectures in embodiments of this application as examples.

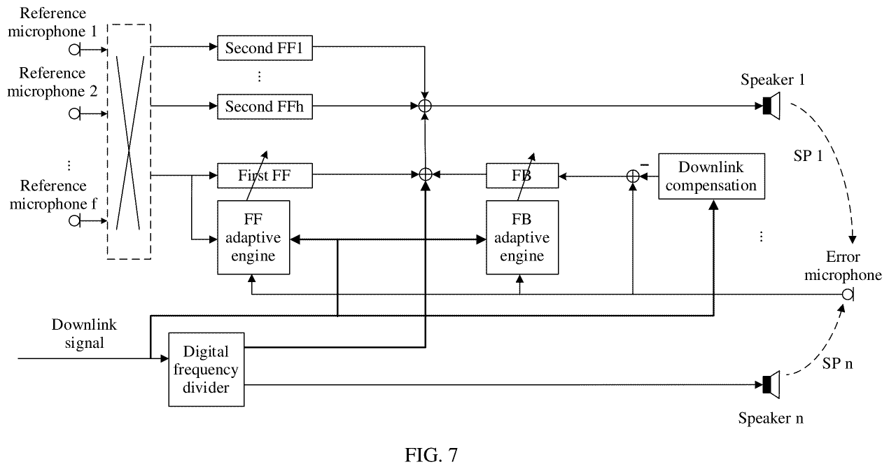

FIG. 7 is a diagram of a structure of a headset according to an embodiment of this application. Refer to FIG. 7. The headset includes f first reference microphones, one error microphone, one first FF filter, one FF adaptive engine, one FB filter, one FB adaptive engine, h second FF filters, n speakers, a downlink compensation filter, a downlink compensation adaptive engine (not shown in the figure), and a digital frequency divider. At a same noise canceling level, a filter coefficient of each second FF filter is fixed, both f and n are integers greater than or equal to 1, and f and n may be equal or unequal.

The f first reference microphones are configured to collect a noise signal of an external environment, namely, a reference signal. The error microphone is configured to collect a noise signal, namely, an error signal, in an ear canal. The FF adaptive engine is configured to: determine a k^{th}-frame filter coefficient of the first FF filter, and refresh the determined k^{th}-frame filter coefficient into the first FF filter. The FB adaptive engine is configured to: determine a k^{th}-frame filter coefficient of the FB filter, and refresh the determined k^{th}-frame filter coefficient into the FB filter. The downlink compensation adaptive engine is configured to: determine a k^{th}-frame filter coefficient of the downlink compensation filter, and refresh the determined k^{th}-frame filter coefficient into the downlink compensation filter. The digital frequency divider is configured to perform, based on a sound-making frequency band of the n speakers, frequency division on a k^{th}-frame downlink signal sent by a user terminal, to obtain a k^{th}-frame downlink signal corresponding to each speaker.

When noise cancellation is performed, the first FF filter is configured to process, based on the k^{th}-frame filter coefficient, k^{th}-frame reference signals collected by the f first reference microphones, to obtain first feedforward inverse phase noise. Each second FF filter is configured to process, based on a k^{th}-frame filter coefficient of the filter, the k^{th}-frame reference signals collected by the f first reference microphones, to obtain second feedforward inverse phase noise. The downlink compensation filter is configured to perform, based on the k^{th}-frame filter coefficient of the downlink compensation filter, downlink compensation on the k^{th}-frame downlink signal sent by the user terminal. Then, after negation is performed on a k^{th}-frame downlink signal obtained through downlink compensation, audio mixing is performed on a negated k^{th}-frame downlink signal and a k^{th}-frame error signal collected by the error microphone, to obtain a k^{th}-frame noise signal collected by the error microphone. The FB filter is configured to process, based on the k^{th} frame filter coefficient of the FB filter, the k^{th}-frame noise signal collected by the error microphone, to obtain feedback inverse phase noise. Then, after audio mixing is performed on the first feedforward inverse phase noise, the second feedforward inverse phase noise, the feedback inverse phase noise, and a k^{th}-frame downlink signal of a target speaker (namely, a speaker 1) in the n speakers, an obtained signal is played through the target speaker, to implement noise cancellation.

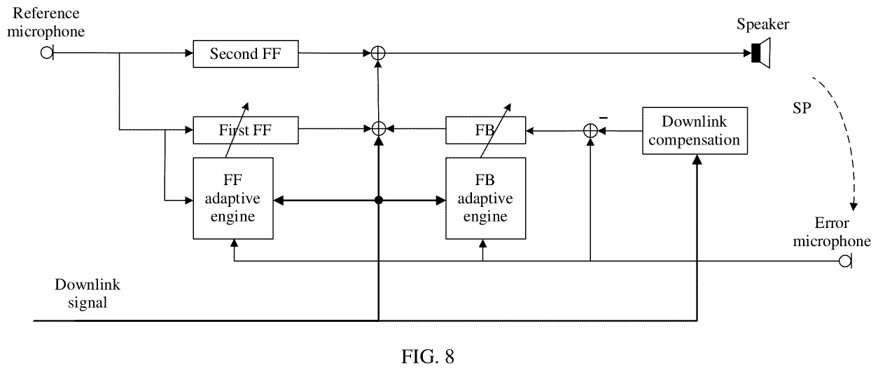

FIG. 8 is a diagram of a structure of another headset according to an embodiment of this application. Refer to FIG. 8. The headset includes one first reference microphone, one error microphone, one first FF filter, one FF adaptive engine, one FB filter, one FB adaptive engine, one second FF filter, one speaker, a downlink compensation filter, and a downlink compensation adaptive engine (not shown in the figure). The speaker is a target speaker.

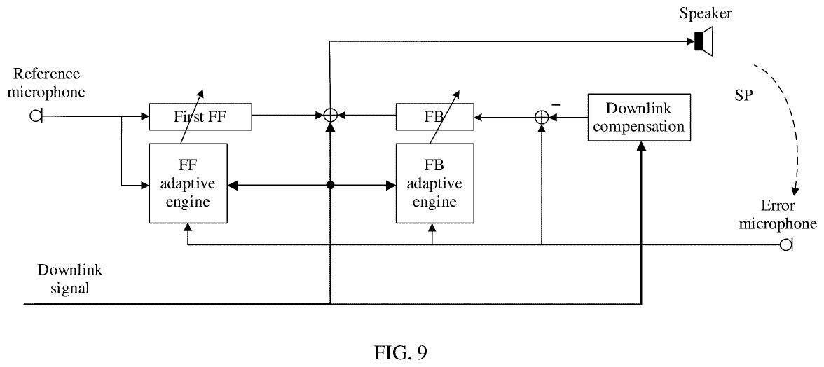

FIG. 9 is a diagram of a structure of another headset according to an embodiment of this application. Refer to FIG. 9. The headset includes one first reference microphone, one error microphone, one first FF filter, one FF adaptive engine, one FB filter, one FB adaptive engine, one speaker, a downlink compensation filter, and a downlink compensation adaptive engine (not shown in the figure). The speaker is a target speaker.

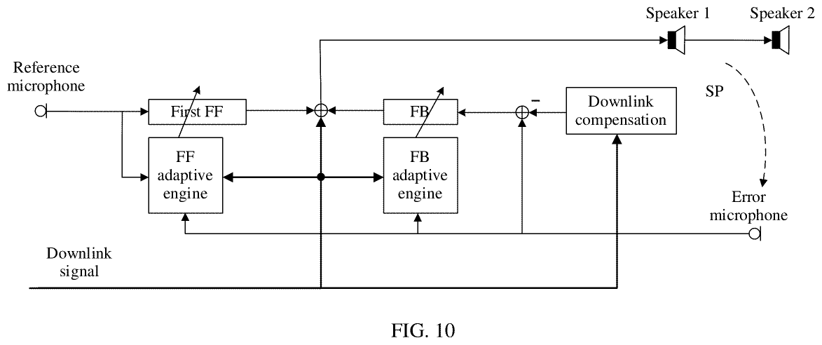

FIG. 10 is a diagram of a structure of another headset according to an embodiment of this application. Refer to FIG. 10. The headset includes one first reference microphone, one error microphone, one first FF filter, one FF adaptive engine, one FB filter, one FB adaptive engine, two speakers, a downlink compensation filter, and a downlink compensation adaptive engine (not shown in the figure). The two speakers are treble and bass speakers. The two speakers are one speaker in terms of a physical entity. Therefore, the headset may not include a digital frequency divider. In other words, the two speakers are driven by using a same DAC and PA to perform analog frequency division. When noise cancellation is performed, both the two speakers may be used as target speakers to participate in noise cancellation.

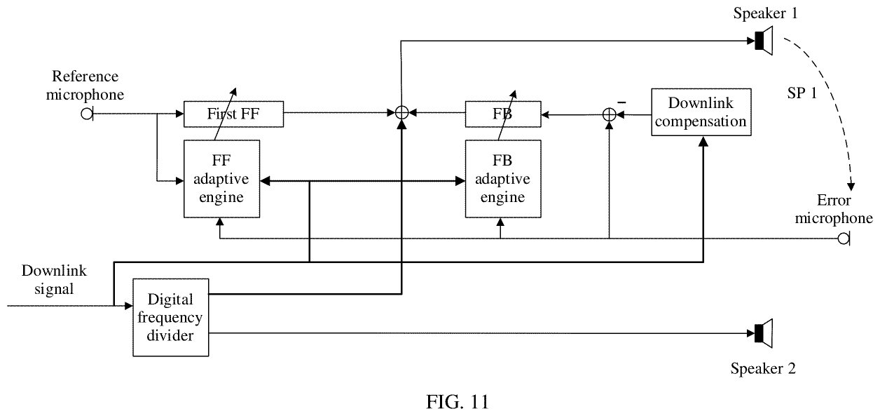

FIG. 11 is a diagram of a structure of another headset according to an embodiment of this application. Refer to FIG. 11. The headset includes one first reference microphone, one error microphone, one first FF filter, one FF adaptive engine, one FB filter, one FB adaptive engine, two speakers, a downlink compensation filter, a downlink compensation adaptive engine (not shown in the figure), and a digital frequency divider. A difference from FIG. 10 lies in that the two speakers are two speakers with a separate loudspeaker and are driven by different DACs and PAs, and digital frequency division needs to be performed on the two speakers. To support high-definition sound quality, the two speakers may use treble and bass loudspeakers. A speaker 1 is a bass unit, and is a main driving loudspeaker of ANC. The speaker 2 is a treble unit, serves only a sound quality channel, and does not contribute to noise cancellation.

When noise cancellation is performed, one of the two speakers (namely, the speaker 1) serving as a target speaker participates in noise cancellation. The other speaker (namely, the speaker 2) serving as a second speaker does not participate in noise cancellation, but the second speaker participates in downlink compensation (that is, downlink compensation is performed on a downlink signal sent by a user terminal, where the downlink signal is a full-band audio signal, including an audio signal at a sound-making frequency band of the second speaker). The first speaker may be a medium-band speaker or a low-band speaker, or may be a full-band speaker. The second speaker may be a high-band speaker. Certainly, the second speaker may be a medium-band speaker or a low-band speaker.

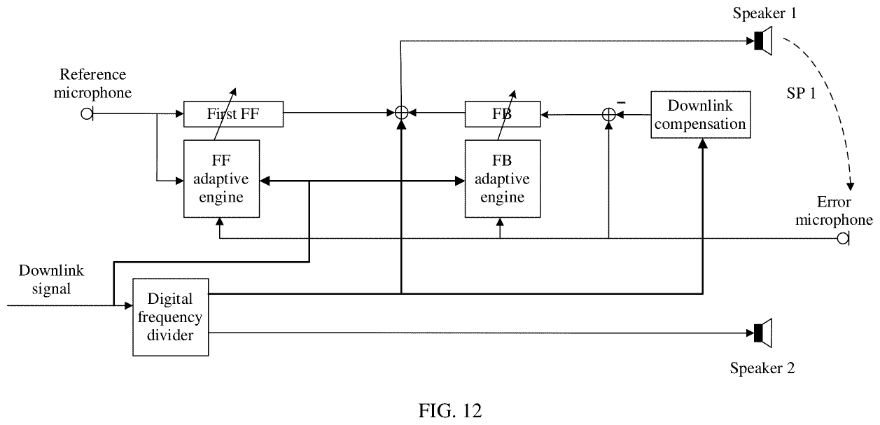

Optionally, a current mainstream ANC chip may not obtain a signal of a high-band speaker. Therefore, refer to FIG. 12. The second speaker may not participate in downlink compensation (that is, after digital frequency division is performed on the downlink signal sent by the user terminal, a downlink signal corresponding to the first speaker is obtained, and downlink compensation is performed on the downlink signal corresponding to the first speaker, and is not performed on a downlink signal corresponding to the second speaker). In this case, the first speaker may be a low- and medium-band speaker, or may be a full-band speaker, and the second speaker may be a high-band speaker. To reduce damage of ANC to downlink sound quality, a frequency division point of the high-band speaker may be above 6 kHz, that is, an audio signal above 6 kHz is not compensated. Certainly, a frequency division point at 6 kHz is not limited in embodiments of this application, and there may be another high frequency division point.

It should be noted that the FF adaptive engine, the FB adaptive engine, and the downlink compensation adaptive engine mentioned above may be deployed on a micro control unit. The FF filter, the FB filter, and the downlink compensation filter may be deployed on an ANC chip. The micro control unit and the ANC chip may be integrated on one chip, or may be deployed on a plurality of chips.

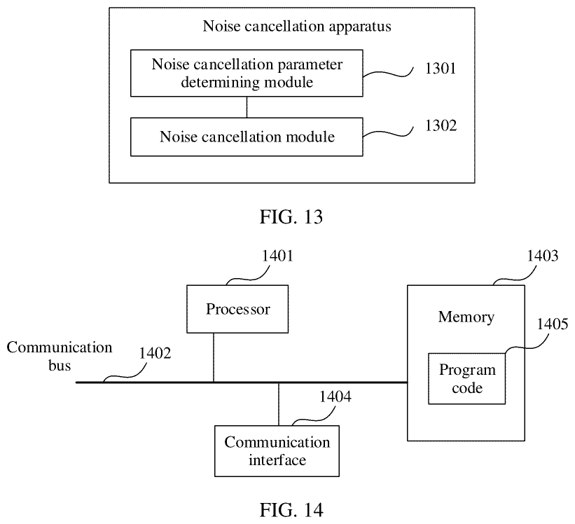

FIG. 13 is a diagram of a structure of a noise cancellation apparatus according to an embodiment of this application. The noise cancellation apparatus may be implemented as a part or all of a headset by software, hardware, or a combination thereof. The headset may be the headset shown in FIG. 1. Refer to FIG. 13. The apparatus includes a noise cancellation parameter determining module 1301 and a noise cancellation module 1302.

The noise cancellation parameter determining module 1301 is configured to determine a target noise cancellation parameter based on a reference signal collected by at least one first reference microphone, an error signal collected by an error microphone, and an initial noise cancellation coefficient, where the target noise cancellation parameter includes a filter coefficient of a first FF filter.

The noise cancellation module 1302 is configured to perform noise cancellation through a target speaker in at least one speaker based on the target noise cancellation parameter.

Optionally, the initial noise cancellation coefficient includes an initial filter coefficient of the first FF filter, and the target noise cancellation parameter includes a k^{th}-frame filter coefficient of the first FF filter, where k is an integer greater than or equal to 1.

The noise cancellation parameter determining module 1301 includes:
a first FF filter coefficient determining submodule, configured to: when k is equal to 1, determine the initial filter coefficient of the first FF filter as the k^{th}-frame filter coefficient of the first FF filter, or determine the k^{th}-frame filter coefficient of the first FF filter based on an initial noise canceling level and a mapping relationship between a noise canceling level and a first FF filter coefficient; or
a second FF filter coefficient determining submodule, configured to: when k is greater than 1, determine the k^{th}-frame filter coefficient of the first FF filter based on a (k−1)^{th}-frame reference signal collected by the at least one first reference microphone, a (k−1)^{th}-frame error signal collected by the error microphone, and a target noise canceling level.

Optionally, the second FF filter coefficient determining submodule is specifically configured to:
determine a (k−1)^{th}-frame filter coefficient of a target secondary path SP based on the target noise canceling level and a mapping relationship between a noise canceling level and a filter coefficient of an SP, where the target SP is a path from the target speaker to the error microphone; and
determine the k^{th}-frame filter coefficient of the first FF filter based on the (k−1)^{th}-frame reference signal collected by the at least one first reference microphone, the (k−1)^{th}-frame error signal collected by the error microphone, and the (k−1)^{th}-frame filter coefficient of the target SP.

Optionally, the second FF filter coefficient determining submodule is further specifically configured to:
determine a residual error based on the (k−1)^{th}-frame reference signal collected by the at least one first reference microphone and the (k−1)^{th}-frame error signal collected by the error microphone;
determine k^{th}-frame frequency response information of the first FF filter based on (k−1)^{th}-frame frequency response information of the first FF filter, the (k−1)^{th}-frame filter coefficient of the target SP, and the residual error; and
determine the k^{th}-frame filter coefficient of the first FF filter based on the k^{th}-frame frequency response information of the first FF filter.

Optionally, the headset further includes one feedback FB filter.

The second FF filter coefficient determining submodule is further specifically configured to:
determine the k^{th}-frame frequency response information of the first FF filter based on the (k−1)^{th}-frame frequency response information of the first FF filter, a (k−1)^{th}-frame filter coefficient of the FB filter, the (k−1)^{h}-frame filter coefficient of the target SP, and the residual error.

Optionally, the second FF filter coefficient determining submodule is further specifically configured to:
establish a loss function between a filter coefficient variable of the first FF filter and the k^{th}-frame frequency response information of the first FF filter;
determine a value of the filter coefficient variable based on the loss function according to a gradient descent method; and
determine the k^{th}-frame filter coefficient of the first FF filter based on the value of the filter coefficient variable.

Optionally, the second FF filter coefficient determining submodule is further specifically configured to:
determine a target noise cancellation amplitude based on an environmental volume; and
determine the value of the filter coefficient variable based on the target noise cancellation amplitude and the loss function according to the gradient descent method.

Optionally, the headset further includes the feedback FB filter, the initial noise cancellation coefficient includes an initial filter coefficient of the FB filter, and the target noise cancellation parameter further includes a k^{th}-frame filter coefficient of the FB filter, where k is an integer greater than or equal to 1.

The noise cancellation parameter determining module 1301 further includes:
a first FB filter coefficient determining submodule, configured to: when k is equal to 1, determine the initial filter coefficient of the FB filter as the k^{th}-frame filter coefficient of the FB filter, or determine the k^{th}-frame filter coefficient of the FB filter based on the initial noise canceling level and a mapping relationship between a noise canceling level and an FB filter coefficient; or
a second FB filter coefficient determining submodule, configured to: when k is greater than 1, determine the k^{th}-frame filter coefficient of the FB filter based on the target noise canceling level and a mapping relationship between a noise canceling level and an FB filter coefficient, or determine the k^{th}-frame filter coefficient of the FB filter based on the (k−1)^{th}-frame error signal collected by the error microphone, the (k−1)^{th}-frame filter coefficient of the FB filter, and the target noise canceling level.

Optionally, the second FB filter coefficient determining submodule is specifically configured to:
determine a (k−1)^{th}-frame filter coefficient of a target secondary path SP based on the target noise canceling level and a mapping relationship between a noise canceling level and a filter coefficient of an SP, where the target SP is a path from the target speaker to the error microphone; and
determine the k^{th}-frame filter coefficient of the FB filter based on the (k−1)^{th}-frame error signal collected by the error microphone, the (k−1)^{th}-frame filter coefficient of the FB filter, and the (k−1)^{th}-frame filter coefficient of the target SP.

Optionally, a filter coefficient of the first FF filter includes at least one biquad filter coefficient and one gain.

Optionally, the headset further includes at least one second FF filter.

The noise cancellation module 1302 is specifically configured to:
determine a k^{th}-frame filter coefficient of the at least one second FF filter; and
perform noise cancellation through the target speaker based on the target noise cancellation parameter and the k^{th}-frame filter coefficient of the at least one second FF filter.

Optionally, the initial noise cancellation coefficient includes an initial filter coefficient of the at least one second FF filter.

The noise cancellation module 1302 is further specifically configured to:
when k is equal to 1, determine the initial filter coefficient of the at least one second FF filter as the k^{th}-frame filter coefficient of the at least one second FF filter, or determine the k^{th}-frame filter coefficient of the at least one second FF filter based on the initial noise canceling level and a mapping relationship between a noise canceling level and a second FF filter coefficient; or
when k is greater than 1, determine the k^{th}-frame filter coefficient of the at least one second FF filter based on the target noise canceling level and a mapping relationship between a noise canceling level and a second FF filter coefficient.

Optionally, the headset further includes a downlink compensation filter, and the initial noise cancellation coefficient includes an initial filter coefficient of the downlink compensation filter. The noise cancellation parameter determining module 1301 further includes:
a first compensation coefficient determining submodule, configured to: when k is equal to 1, determine the initial filter coefficient of the downlink compensation filter as a k^{th}-frame filter coefficient of the downlink compensation filter, or determine a k^{th}-frame filter coefficient of the downlink compensation filter based on the initial noise canceling level and a mapping relationship between a noise canceling level and a downlink compensation filter coefficient; or
a second compensation coefficient determining submodule, configured to: determine a k^{th}-frame filter coefficient of the downlink compensation filter based on the target noise canceling level and a mapping relationship between a noise canceling level and a downlink compensation filter coefficient.

In conclusion, in embodiments of this application, the target noise cancellation parameter is determined based on the reference signal collected by the at least one first reference microphone, the error signal collected by the error microphone, and the initial noise cancellation coefficient. This eliminates dependence on a downlink signal, so that the target noise cancellation parameter can be determined even when there is no downlink signal, to perform adaptive noise cancellation.

It should be noted that, during noise cancellation performed by the noise cancellation apparatus provided in embodiments, division of the function modules is only used as an example for description. In actual application, the functions may be allocated to different function modules for implementation, depending on a requirement. In other words, an internal structure of an apparatus is divided into different function modules to implement all or some of the functions described above. In addition, the noise cancellation apparatus provided in embodiments and embodiments of the noise cancellation method pertain to a same concept. For a specific implementation process of the noise cancellation apparatus, refer to the method embodiments. Details are not described herein again.

Refer to FIG. 14. FIG. 14 is a diagram of a structure of another headset according to an embodiment of this application. The headset includes one or more processors 1401, a communication bus 1402, a memory 1403, and one or more communication interfaces 1404.

The processor 1401 is a general-purpose central processing unit (CPU), a network processor (NP), a microprocessor, or one or more integrated circuits configured to implement the solutions of this application, for example, an application-specific integrated circuit (ASIC), a programmable logic device (PLD), or a combination thereof. Optionally, the PLD is a complex programmable logic device (CPLD), a field-programmable gate array (FPGA), generic array logic (GAL), or any combination thereof.

The communication bus 1402 is configured to transmit information between the foregoing components. Optionally, the communication bus 1402 is classified as an address bus, a data bus, a control bus, and the like. For ease of representation, only one thick line is used to represent the bus in the figure, but this does not mean that there is only one bus or only one type of bus.

Optionally, the memory 1403 is a read-only memory (read-only memory, ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, and the like), a magnetic disk storage medium, another magnetic storage device, or any other medium that can be used to carry or store expected program code in a form of an instruction or a data structure and that can be accessed by a computer, but is not limited thereto. The memory 1403 exists independently, and is connected to the processor 1401 through the communication bus 1402, or the memory 1403 is integrated with the processor 1401.

The communication interface 1404 is configured to communicate with another device or a communication network by using any transceiver-type apparatus. The communication interface 1404 includes a wired communication interface, or optionally includes a wireless communication interface. The wired communication interface is, for example, an Ethernet interface. Optionally, the Ethernet interface is an optical interface, an electrical interface, or a combination thereof. The wireless communication interface is a wireless local area network (WLAN) interface, a cellular network communication interface, a combination thereof, or the like.

In some embodiments, the memory 1403 is configured to store program code 1405 for executing the solutions of this application. The processor 1401 can execute the program code 1405 stored in the memory 1403. The program code includes one or more software modules, and the headset can implement, through the processor 1401 and the program code 1405 in the memory 1403, the noise cancellation method provided in embodiments in FIG. 2.

All or some of the foregoing embodiments may be implemented by using software, hardware, firmware, or any combination thereof. When software is used to implement the foregoing embodiments, all or some of embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device like a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid-state disk (SSD)), or the like. It should be noted that the computer-readable storage medium mentioned in embodiments of this application may be a non-volatile storage medium, that is, may be a non-transitory storage medium.

An embodiment of this application further provides a computer-readable storage medium. The storage medium stores a computer program, and when the computer program is executed by a processor, the steps of the foregoing method are implemented.

An embodiment of this application further provides a computer program product. The computer program product stores computer instructions, and when the computer instructions are executed by a processor, the steps of the foregoing method are implemented.

It should be understood that “at least one” mentioned in this specification indicates one or more, and “a plurality of” indicates two or more. In the descriptions of embodiments of this application, “/” indicates “or” unless otherwise specified. For example, A/B may indicate A or B. In this specification, “and/or” describes only an association relationship between associated objects and indicates that three relationships may exist. For example, A and/or B may indicate the following three cases: Only A exists, both A and B exist, and only B exists. In addition, to clearly describe the technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions.

The foregoing descriptions are merely embodiments of this application, but are not intended to limit this application. Any modification, equivalent replacement, or improvement made without departing from the spirit and principle of this application should fall within the protection scope of this application.

1. A noise cancellation method, applied to a headset, wherein the headset comprises at least one first reference microphone, one error microphone, at least one speaker, and one first feedforward (FF) filter, and the method comprises:
determining a target noise cancellation parameter based on a reference signal collected by the at least one first reference microphone, an error signal collected by the error microphone, and an initial noise cancellation coefficient, wherein the target noise cancellation parameter comprises a filter coefficient of the first FF filter; and
performing noise cancellation through a target speaker in the at least one speaker based on the target noise cancellation parameter.

2. The method according to claim 1, wherein the initial noise cancellation coefficient comprises an initial filter coefficient of the first FF filter, and the target noise cancellation parameter comprises a k^{th}-frame filter coefficient of the first FF filter, wherein k is an integer greater than or equal to 1; and
the determining a target noise cancellation parameter based on a reference signal collected by the at least one first reference microphone, an error signal collected by the error microphone, and an initial noise cancellation coefficient comprises:
when k is equal to 1, determining the initial filter coefficient of the first FF filter as the k^{th}-frame filter coefficient of the first FF filter, or determining the k^{th}-frame filter coefficient of the first FF filter based on an initial noise canceling level and a mapping relationship between a noise canceling level and a first FF filter coefficient; or
when k is greater than 1, determining the k^{th}-frame filter coefficient of the first FF filter based on a (k−1)^{th}-frame reference signal collected by the at least one first reference microphone, a (k−1)^{th}-frame error signal collected by the error microphone, and a target noise canceling level.

3. The method according to claim 2, wherein the determining the k^{th}-frame filter coefficient of the first FF filter based on a (k−1)^{th}-frame reference signal collected by the at least one first reference microphone, a (k−1)^{th}-frame error signal collected by the error microphone, and a target noise canceling level comprises:
determining a (k−1)^{th}-frame filter coefficient of a target secondary path SP based on the target noise canceling level and a mapping relationship between a noise canceling level and a filter coefficient of an SP, wherein the target SP is a path from the target speaker to the error microphone; and
determining the k^{th}-frame filter coefficient of the first FF filter based on the (k−1)^{th}-frame reference signal collected by the at least one first reference microphone, the (k−1)^{th}-frame error signal collected by the error microphone, and the (k−1)^{th}-frame filter coefficient of the target SP.

4. The method according to claim 3, wherein the determining the k^{th}-frame filter coefficient of the first FF filter based on the (k−1)^{th}-frame reference signal collected by the at least one first reference microphone, the (k−1)^{th}-frame error signal collected by the error microphone, and the (k−1)^{th}-frame filter coefficient of the target SP comprises:
determining a residual error based on the (k−1)^{th}-frame reference signal collected by the at least one first reference microphone and the (k−1)^{th}-frame error signal collected by the error microphone;
determining k^{th}-frame frequency response information of the first FF filter based on (k−1)^{th}-frame frequency response information of the first FF filter, the (k−1)^{th}-frame filter coefficient of the target SP, and the residual error; and
determining the k^{th}-frame filter coefficient of the first FF filter based on the k^{th}-frame frequency response information of the first FF filter.

5. The method according to claim 4, wherein the headset further comprises one feedback FB filter, and
the determining k^{th}-frame frequency response information of the first FF filter based on (k−1)^{th}-frame frequency response information of the first FF filter, the (k−1)^{th}-frame filter coefficient of the target SP, and the residual error comprises:
determining the k^{th}-frame frequency response information of the first FF filter based on the (k−1)^{th}-frame frequency response information of the first FF filter, a (k−1)^{th}-frame filter coefficient of the FB filter, the (k−1)^{h}-frame filter coefficient of the target SP, and the residual error.

6. The method according to claim 4, wherein the determining the k^{th}-frame filter coefficient of the first FF filter based on the k^{th}-frame frequency response information of the first FF filter comprises:
establishing a loss function between a filter coefficient variable of the first FF filter and the k^{th}-frame frequency response information of the first FF filter;
determining a value of the filter coefficient variable based on the loss function according to a gradient descent method; and
determining the k^{th}-frame filter coefficient of the first FF filter based on the value of the filter coefficient variable.

7. The method according to claim 6, wherein the determining a value of the filter coefficient variable based on the loss function according to a gradient descent method comprises:
determining a target noise cancellation amplitude based on an environmental volume; and
determining the value of the filter coefficient variable based on the target noise cancellation amplitude and the loss function according to the gradient descent method.

8. The method according to claim 1, wherein the headset further comprises the one feedback FB filter, the initial noise cancellation coefficient comprises an initial filter coefficient of the FB filter, and the target noise cancellation parameter further comprises a k^{th}-frame filter coefficient of the FB filter, wherein k is an integer greater than or equal to 1; and
the determining a target noise cancellation parameter based on a reference signal collected by the at least one first reference microphone, an error signal collected by the error microphone, and an initial noise cancellation coefficient further comprises:
when k is equal to 1, determining the initial filter coefficient of the FB filter as the k^{th}-frame filter coefficient of the FB filter, or determining the k^{th}-frame filter coefficient of the FB filter based on the initial noise canceling level and a mapping relationship between a noise canceling level and an FB filter coefficient; or
when k is greater than 1, determining the k^{th}-frame filter coefficient of the FB filter based on the target noise canceling level and a mapping relationship between a noise canceling level and an FB filter coefficient, or determining the k^{th}-frame filter coefficient of the FB filter based on the (k−1)^{th}-frame error signal collected by the error microphone, the (k−1)^{th}-frame filter coefficient of the FB filter, and the target noise canceling level.

9. The method according to claim 8, wherein the determining the k^{th}-frame filter coefficient of the FB filter based on the (k−1)^{h}-frame error signal collected by the error microphone, a (k−1)^{th}-frame filter coefficient of the FB filter, and the target noise canceling level comprises:
determining the (k−1)^{th}-frame filter coefficient of the target secondary path SP based on the target noise canceling level and the mapping relationship between the noise canceling level and the filter coefficient of the SP, wherein the target SP is the path from the target speaker to the error microphone; and
determining the k^{th}-frame filter coefficient of the FB filter based on the (k−1)^{th}-frame error signal collected by the error microphone, the (k−1)^{h}-frame filter coefficient of the FB filter, and the (k−1)^{th}-frame filter coefficient of the target SP.

10. The method according to claim 1, wherein a filter coefficient of the first FF filter comprises at least one biquad filter coefficient and one gain.

11. The method according to claim 1, wherein the headset further comprises at least one second FF filter, and
the performing noise cancellation through a target speaker in the at least one speaker based on the target noise cancellation parameter comprises:
determining a k^{th}-frame filter coefficient of the at least one second FF filter; and
performing noise cancellation through the target speaker based on the target noise cancellation parameter and the k^{th}-frame filter coefficient of the at least one second FF filter.

12. The method according to claim 1, wherein the headset further comprises a downlink compensation filter, and the initial noise cancellation coefficient comprises an initial filter coefficient of the downlink compensation filter; and
the determining a target noise cancellation parameter based on a reference signal collected by the at least one first reference microphone, an error signal collected by the error microphone, and an initial noise cancellation coefficient further comprises:
when k is equal to 1, determining the initial filter coefficient of the downlink compensation filter as a k^{th}-frame filter coefficient of the downlink compensation filter, or determining a k^{th}-frame filter coefficient of the downlink compensation filter based on the initial noise canceling level and a mapping relationship between a noise canceling level and a downlink compensation filter coefficient; or
when k is greater than 1, determining a k^{th}-frame filter coefficient of the downlink compensation filter based on the target noise canceling level and a mapping relationship between a noise canceling level and a downlink compensation filter coefficient.

13. A headset, wherein the headset comprises at least one first reference microphone, one error microphone, at least one speaker, one first feedforward FF filter, and one noise cancellation processor, wherein
the noise cancellation processor is configured to implement steps of the method comprising:
determining a target noise cancellation parameter based on a reference signal collected by the at least one first reference microphone, an error signal collected by the error microphone, and an initial noise cancellation coefficient, wherein the target noise cancellation parameter comprises a filter coefficient of the first FF filter; and
performing noise cancellation through a target speaker in the at least one speaker based on the target noise cancellation parameter.

14. The headset according to claim 13, wherein the at least one speaker comprises a first speaker and a second speaker on which digital frequency division is performed, a target speaker is the first speaker, and the second speaker does not participate in noise cancellation.

15. The headset according to claim 14, wherein the second speaker participates in downlink compensation.

16. The headset according to claim 14, wherein the second speaker does not participate in downlink compensation, and the second speaker is a high-band speaker.

17. The headset according to claim 13, wherein the at least one speaker comprises a first speaker and a second speaker on which analog frequency division is performed, and the target speaker is the first speaker and the second speaker.

18. The headset according to claim 13, wherein the headset further comprises at least one second FF filter, and a filter coefficient of the second FF filter is fixed at a same noise canceling level.

19. The headset according to claim 18, wherein the headset further comprises a plurality of second reference microphones, the first FF filter corresponds to the at least one first reference microphone, and each of the at least one second FF filter corresponds to at least one second reference microphone in the plurality of second reference microphones.

20. A computer-readable storage medium, wherein the storage medium stores a computer program, and when the computer program is executed by a processor, cause the processor to perform the steps in the method comprising:
determining a target noise cancellation parameter based on a reference signal collected by the at least one first reference microphone, an error signal collected by the error microphone, and an initial noise cancellation coefficient, wherein the target noise cancellation parameter comprises a filter coefficient of the first FF filter; and
performing noise cancellation through a target speaker in the at least one speaker based on the target noise cancellation parameter.
